(19) United States
(12) Patent Application Publication
(10) Pub. No.: US 2015/0246483 A1
(43) Pub. Date: Sep. 3, 2015

(54) THREE-DIMENSIONAL SHAPED OBJECT MANUFACTURING DEVICE, MANUFACTURING METHOD OF THREE-DIMENSIONAL SHAPED OBJECT, AND THREE-DIMENSIONAL SHAPED OBJECT

(71) Applicant: SEIKO EPSON CORPORATION, Tokyo (JP)

(72) Inventors: Junichi GOTO, Matsumoto (JP); Eiji OKAMOTO, Matsumoto (JP)

(21) Appl. No.: 14/625,595

(22) Filed: Feb. 18, 2015

(30) Foreign Application Priority Data
Mar. 3, 2014 (JP) 2014-040159

(51) Int. Cl. B29C 67/00

(52) U.S. Cl. CPC B29C 67/0055; B29C 67/0085; B33Y 10/00

(57) ABSTRACT

A three-dimensional shaped object manufacturing device is adapted to produce a three-dimensional shaped object by laminating layers using a pasty composition containing granular substances. The three-dimensional shaped object manufacturing device includes a stage in which the composition is supplied and the layers are formed, a side surface supporting section arranged on a side surface of the stage, and an adhesion preventing part configured and arranged to prevent adhesion of the composition on a surface of the side surface supporting section. The stage is movable relative to the side surface supporting section in a lamination direction of the layers.

### CROSS-REFERENCE TO RELATED APPLICATIONS

This application claims priority to Japanese Patent Application No. 2014-040159 filed on Mar. 3, 2014. The entire disclosure of Japanese Patent Application No. 2014-040159 is hereby incorporated herein by reference.

### BACKGROUND

1. Technical Field

The present invention relates to a three-dimensional shaped object manufacturing device, a manufacturing method of a three-dimensional shaped object, and a three-dimensional shaped object.

2. Related Art

A technology for shaping a three-dimensional shaped object by forming material layers (unit layers) using a compound containing powder (granular materials) and then laminating these layers is known (see, e.g., Japanese Unexamined Patent Application Publication No. 2003-53847). In this technology, a three-dimensional shaped object is shaped by repeating the following operations. Initially, a material layer is formed by thinly laying powders with a uniform thickness, and the powders are selectively joined each other only at a desired portion of this material layer to thereby form a joined portion. As a result, a thin plate-like member (hereinafter referred to as “cross-section member”) is formed at the joined portion in which the powder is joined. Thereafter, on the material layer, another material layer is further formed thinly, and only at a desired portion thereof, the powder is selectively joined to thereby form a joined portion. As a result, also in the newly formed material layer, a new cross-section member is formed. At this time, the newly formed cross-section member is also joined to the previously formed cross-section member. By repeating such operations to laminate the thin plate-like cross-section members (joined portions) one-layer by one-layer, a three-dimensional shaped object can be shaped.

In such a method, for the purpose of, e.g., improving the workability at the time of forming a material layer by increasing fluidity of a composition, or preventing unintentional scattering, etc., of powder at the time of forming the material layer, in some cases, as the composition, a past-like substance containing a component in the form of a liquid at the time of forming a material layer (liquid component) is used.

In such technology, however, when lowering a stage on which the material layer was formed to form a new material, disorder sometimes causes in the material layer. In such a case, the obtained three-dimensional shaped object has defects or lower dimensional accuracy. Further, depending on circumstances, it sometimes becomes impossible to perform manufacturing itself of a three-dimensional shaped object.

### SUMMARY

Objects of the present invention are to provide a three-dimensional shaped object manufacturing device capable of effectively manufacturing a three-dimensional shaped object excellent in dimensional accuracy and effectively prevented in occurrence of defects, to provide a manufacturing method of a three-dimensional shaped object manufacturing device capable of effectively manufacturing a three-dimensional shaped object excellent in dimensional accuracy and effectively prevented in occurrence of defects, and to provide the three-dimensional shaped object manufacturing device and the three-dimensional shaped object manufactured using the manufacturing method of the three-dimensional shaped object.

A three-dimensional shaped object manufacturing device according to one aspect is adapted to produce a three-dimensional shaped object by laminating layers using a pasty composition containing granular substances, and includes a stage in which the composition is supplied and the layers are formed, a side surface supporting section arranged on a side surface of the stage, and an adhesion preventing part configured and arranged to prevent adhesion of the composition on a surface of the side surface supporting section. The stage is movable relative to the side surface supporting section in a lamination direction of the layers.

With this, a three-dimensional shaped object manufacturing device capable of effectively producing a three-dimensional shaped object excellent in dimensional accuracy and effectively prevented in occurrence of defects can be provided.

In the three-dimensional shaped object manufacturing device, it is preferable that the adhesion preventing part is a liquid repellent film provided on a surface of the side surface supporting section. With this, it is more effectively prevented that the layer adheres to the side surface supporting section.

In the three-dimensional shaped object manufacturing device, it is preferable that the adhesion preventing part is a heating unit configured and arranged to heat the side surface supporting section. With this, it is possible to more effectively prevent that the layer adheres the side surface supporting section.

In the three-dimensional shaped object manufacturing device, it is preferable that the stage is configured to be movable in the lamination direction of the layers. With this, the structure of the three-dimensional shaped object manufacturing device can be simplified.

In the three-dimensional shaped object manufacturing device, it is preferable that the side surface supporting section is configured to be movable in the lamination direction of the layers.

With this, for example, even in cases where the area of the stage is large, or even in cases where the weight of the three-dimensional shaped object is large, a three-dimensional shaped object can be manufactured preferably.

In the three-dimensional shaped object manufacturing device, it is preferable that the device further includes a bonding liquid application unit configured and arranged to apply a bonding liquid for biding the granular substances.

With this, it becomes possible to easily and assuredly make the mechanical strength of the three-dimensional shaped object excellent.

In the three-dimensional shaped object manufacturing device, it is preferable that the bonding liquid contains an ultraviolet curable resin, and the three-dimensional shaped object manufacturing device is provided with an ultraviolet irradiation unit.

With this, the three-dimensional shaped object to be finally obtained can be made especially excellent in mechanical strength.

In a manufacturing method of a three-dimensional shaped object, the three-dimensional shaped object is manufactured using the three-dimensional shaped object manufacturing device described above.

With this, it is possible to provide a manufacturing method of a three-dimensional shaped object manufacturing device capable of effectively producing a three-dimensional shaped object excellent in dimensional accuracy and effectively prevented in occurrence of defects.

A manufacturing method of a three-dimensional shaped object is a method that performs a series of processes plural times, the series of processes including a layer forming process which forms a layer using a pasty composition containing granular substances, and a moving process which moves the layer downward relative to a side surface supporting section configured and arranged to support a side surface of the layer. The manufacturing method of a three-dimensional shaped object use a device provided with an adhesion preventing part configured and arranged to prevent adhesion of the composition to a surface of the side surface supporting section.

With this, it is possible to provide a manufacturing method of a three-dimensional shaped object capable of effectively producing a three-dimensional shaped object excellent in dimensional accuracy and effectively prevented in occurrence of defects.

In the manufacturing method of the three-dimensional shaped object, it is preferable that the method further includes a bonding liquid application process which applies a bonding liquid for bonding the granular substances to the layer.

With this, it is possible to make the three-dimensional shaped object to be finally obtained excellent in mechanical strength.

The three-dimensional shaped object is a three-dimensional shaped object manufactured using the three-dimensional shaped object manufacturing device described above.

With this, a three-dimensional shaped object capable of effectively producing a three-dimensional shaped object excellent in dimensional accuracy and effectively prevented in occurrence of defects can be provided.

A three-dimensional shaped object is manufactured using the method described above. With this, a three-dimensional shaped object capable of effectively producing a three-dimensional shaped object excellent in dimensional accuracy and effectively prevented in occurrence of defects can be provided.

### BRIEF DESCRIPTION OF THE DRAWINGS

Referring now to the attached drawings which form a part of this original disclosure:

FIGS. 1A-1D are cross-sectional views schematically showing each process of a preferable embodiment of a manufacturing method of a three-dimensional shaped object according to the present invention.

FIGS. 2A-2D are cross-sectional views schematically showing each process of a preferable embodiment of a manufacturing method of a three-dimensional shaped object according to the present invention.

FIGS. 3A-3C are cross-sectional views schematically showing each process of a preferable embodiment of a manufacturing method of a three-dimensional shaped object according to the present invention.

FIG. 4 is a cross-sectional view schematically showing a preferable embodiment of a three-dimensional shaped object manufacturing device according to the present invention.

FIG. 5 is a cross-sectional view schematically showing another preferable embodiment of a three-dimensional shaped object manufacturing device according to the present invention.

FIG. 6 is a cross-sectional view schematically showing a state in a layer (three-dimensional shaping composition) immediately before a bonding liquid application process.

FIG. 7 is a cross-sectional view schematically a state in which granular materials are bonded by a hydrophobic bonding agent.

### DETAILED DESCRIPTION OF EXEMPLARY EMBODIMENTS

Hereinafter, preferable embodiments of the present invention will be detailed with reference to the attached drawings.

### Manufacturing Method of Three-Dimensional Shaped Object

Initially, a manufacturing method of a three-dimensional shaped object of the present invention will be explained.

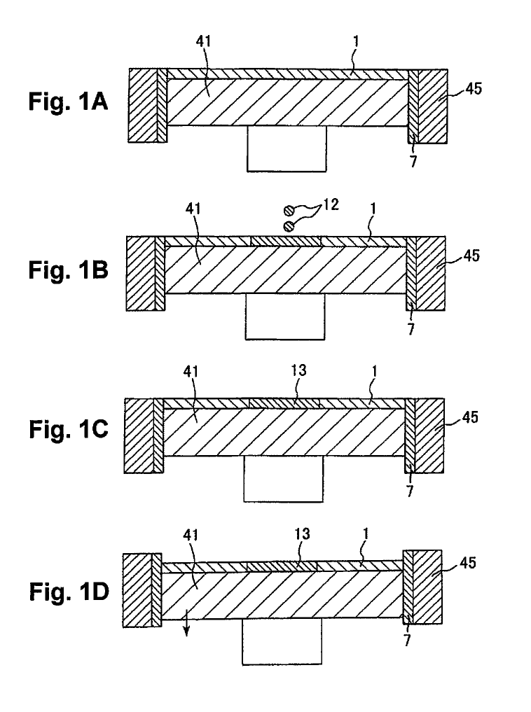

FIGS. 1A-1D, 2A-2D and 3A-3C are cross-sectional views each schematically showing each process of a preferable embodiment of a manufacturing method of a three-dimensional shaped object according to the present invention.

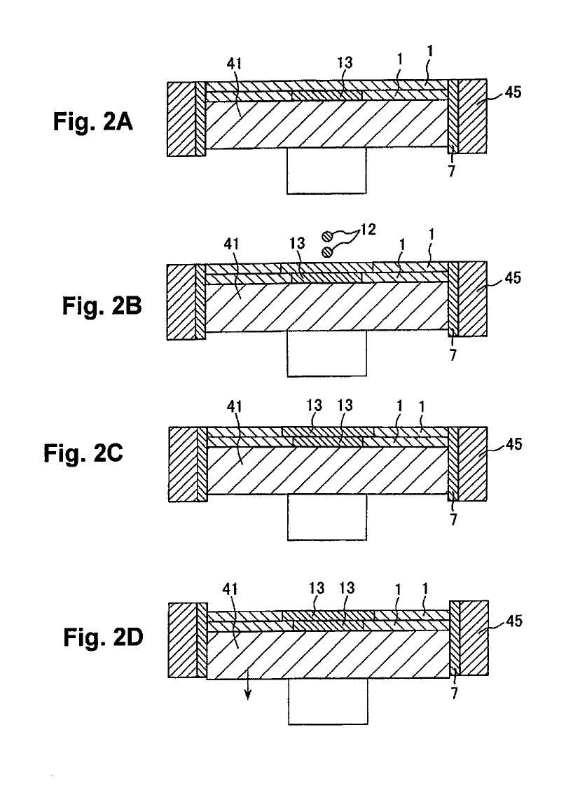

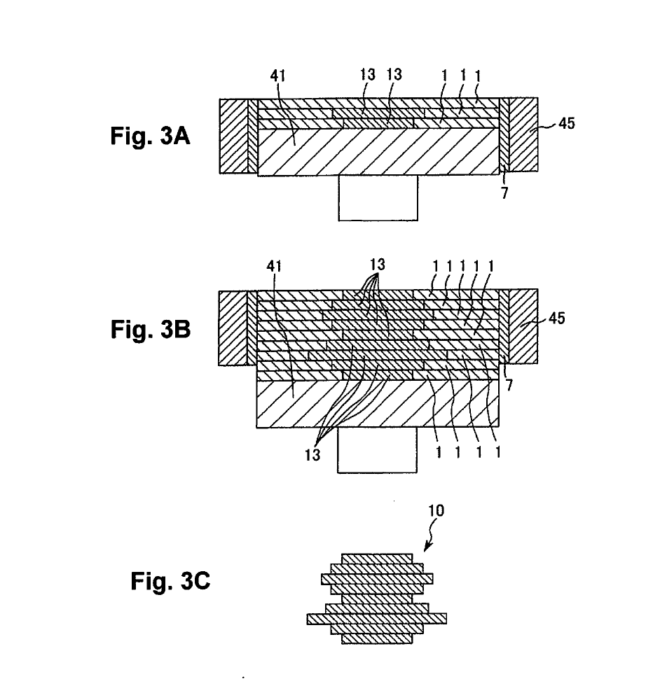

As shown in FIGS. 1A-1D, 2A-2D and 3A-3C, the manufacturing method of this embodiment includes a layer forming process (FIGS. 1A, 1B, 3A) for forming a layer 1 having a predetermined thickness in a region surrounded by a side surface supporting portion (frame) 45 using a pasty composition containing granular substances 111, a binder liquid application process (FIGS. 1B, 2B) for applying a bonding liquid to the layer 1 by an ink jet method, and a curing process (bonding process) (FIGS. 1C, 2C) for forming a cured portion (bonding portion) 13 in the layer 1 by curing the bonding agent 121 contained in the bonding liquid 12 applied to the layer 1 to bind the granular substances 111. These processes are sequentially repeated, and thereafter the manufacturing method further includes an un-bonded particle removal process (FIG. 3C) for removing granular substances 111 not bonded by the bonding agent 121 among the granular substances 111.

Prior to the second and subsequent layer forming processes (process for forming a second layer which is a layer 1 to be newly formed), a moving process (FIGS. 1D, 2D) for lowering the stage 41 is performed.

In the present invention, the terminologies of “first layer,” and “second layer” show a relative relation of two layers among a plurality of layers constituting the three-dimensional shaped object. More specifically, in the relation of forming a (n+1)^{th} layer 1 on a n^{th} layer 1, the n^{th} n layer 1 is referred to as “first layer,” and the (n+1)^{th} layer 1 is referred to as “second layer.” On the other hand, in the relation of forming the (n+2)^{th} layer 1 on the (n+1)^{th} layer, the (n+1)^{th} layer 1 is referred to as “first layer” and the (n+2)^{th} layer 1 is referred to as “second layer.”

Hereinafter, each process will be explained.

### Layer Forming Process

In the layer forming process, a layer 1 having a predetermined thickness is formed using pasty compositions (compositions for three-dimensional shaped object) 11 containing granular substances 111 (FIGS. 1A, 2A, 3A).

By using a pasty substance as the composition 11, the fluidity of the composition 11 is enhanced, which in turn can improve the workability at the time of forming the layer 1. Further, unintentional scattering, etc., of the powder (granular substance 111) at the time of forming the layer 1 can be prevented.

In the present invention, the pasty substance denotes a substance containing a component in the form of a liquid in the layer forming process. For example, substances, such as a substance which contains a solvent component, a substance in the form of a solid at room temperature which contains a component which melts when heated at the layer forming process, etc., are included in the pasty component.

As to the composition 11, the explanation will be detailed later. In this process, using a flattening unit, a layer 1 in which the surface is flattened is formed.

In the first layer forming process, a layer 1 having a predetermined thickness is formed on the surface of the stage 41 (FIG. 1A). At this time, the side surface of the stage 41 and the side surface supporting section 45 are in a close-contact (contact) state, which prevents the composition 11 from falling down between the stage 41 and the side surface supporting section 45.

In the second and subsequent layer forming processes, a new layer 1 (second layer) is formed on the surface of the layer 1 (first layer) formed in the previous process (FIGS. 2A, 3A). At this time, the side surface of the layer 1 (at least the layer 1 formed on the upper most side in the case in which there are a plurality of layers 1 on the stage 41) on the stage 41 and the side surface supporting section 45 are in a close-contact (contact) state, which prevents the composition 11 from falling down between the stage 41 and the layer 1 on the stage 41.

In this process, the composition 11 can be heated. This enables, for example in cases where the composition 11 contains a melting component, to more preferably make the composition 11 in a pasty state.

It is preferable that the viscosity (the value measured using the E-type viscosity (VISCONIC ELD made by Tokyo Keiki, Inc.) of the composition 11 in this process is from 7,000 mPa·s to 60,000 mPa·s, more preferably from 10,000 mPa·s to 50,000 mPa·s. This effectively prevents occurrence of variation of unintentional thickness of the layer 1 to be formed.

The thickness of the layer to be formed in this process is not specifically limited, but is, for example, preferably 30 μm to 500 μm, more preferably 70 μm to 150 μm. With this, while making the productivity of the three-dimensional shaped object 10 sufficiently excellent, occurrence of unintentional unevenness, etc., of the three-dimensional shaped object 10 is more effectively prevented, which enables to make the dimensional accuracy of the three-dimensional shaped object 10 especially excellent.

### Bonding Liquid Application Process

After forming the layer 1 in the layer forming process, a bonding liquid 12 for bonding granular substances 111 constituting the layer 1 is applied to the layer 1 (FIGS. 1B, 2B).

In this process, a bonding liquid 12 is selectively applied only to the portion corresponding to the actual part (substantial part) of the three-dimensional shaped object 10 in the layer 1.

This strongly bonds granular substances 111 constituting the layer 1, which finally forms a cured portion (bonded portion) 13 of a desired shape. Further, the three-dimensional shaped object 10 to be finally obtained can be made excellent in mechanical strength.

In this process, since the bonding liquid 12 is applied by an ink-jet method, even if the application pattern of the bonding liquid 12 is a fine shape, the bonding liquid 12 can be applied with high reproducibility. As a result, a three-dimensional shaped object 10 to be finally obtained can be made especially high in dimensional accuracy. As to the bonding liquid 12, the explanation will be detailed later.

### Curing Process (Bonding Process)

After applying the bonding liquid 12 to the layer 1 in the bonding liquid application process, the bonding agent 121 contained in the bonding liquid 12 applied to the layer 1 is cured to form a cured portion (bonded portion) 13 (FIGS. 1C, 2C). This makes the bonding strength between the bonding agent 121 and the granular substance 111 especially excellent. As a result, the three-dimensional shaped object 10 to be finally obtained can be made especially excellent in mechanical strength.

Although this process differs depending on the kind of the bonding agent 121, for example, in the case in which the bonding agent 121 is a thermosetting resin, the process can be performed by heating, and in the case in which the bonding agent 121 is a light curable resin, the process can be performed by irradiating corresponding light (for example, in the case in which the bonding agent 121 is an ultraviolet curable resin, the process can be performed by irradiating ultraviolet light).

The bonding liquid application process and the curing process can be performed concurrently. That is, it can be configured such that, before the entire pattern of one entire layer 1 is formed, the curing reaction is progressed sequentially from the portion where the bonding liquid 12 was applied.

Further, for example, in the case in which the bonding agent 121 is not a curing component, this process can be omitted. In this case, the aforementioned bonding liquid application process is served also as this bonding process.

### Moving Process

In the moving process, the stage 41 is lowered (FIGS. 1D, 2D).

Accordingly, a step having a height corresponding to the thickness of a layer 1 (second layer) to be newly formed is formed between the upper surface of the side surface supporting section 45 and the upper surface of the layer 1 (first layer) on the stage 41. This enables to form a layer 1 (second layer) having a desired thickness in the following layer forming process.

Further, as an adhesion preventing part, a liquid repellent film 7 is provided on the surface (portion which comes into contact with the composition 11) of the side surface supporting section 45. Further, a heating unit 8 for heating the side surface supporting section 45 is provided.

Since the adhesion preventing part is provided as mentioned above, it becomes possible to assuredly prevent occurrence of unintentional deformation (disorder) in the layer 1 due to the sliding resistance when the stage 41 moves. Consequently, the three-dimensional shaped object 10 to be finally obtained can be made excellent in dimensional accuracy and effectively controlled in occurrence of defects. Further, it can be considered such that only the region where no layer disorder occurs is utilized for a three-dimensional shaped object without utilizing the region where layer disorder occurs. However, in such case, the stage cannot be effectively utilized (utilization area ratio becomes low), which causes problems such that the productivity of the three-dimensional shaped object deteriorates, a large size three-dimensional shaped object cannot be manufactured, etc. However, according to the present invention, the occurrence of such problems can be prevented, and a three-dimensional shaped object can be manufactured effectively. After the layer formation process for forming the last layer 1, no moving process is required. Further, as to the adhesion preventing part, the explanation will be detailed later.

### Un-Bonded Particle Removal Process

After repeating the series of processes as mentioned above, as a post treatment process, an un-bonded particle removal process (FIG. 3C) for removing granular substances 111 not bonded by the bonding agent 121 among the granular substances 111 constituting each layer 1 (non-bonded particles) is performed. With this, a three-dimensional shaped object 10 is taken out.

As concrete methods of this process, for example, a method of brushing away un-bonded particles with a brush, etc., a method of removing un-bonded particles by suction, a method of blowing gas such as air, etc., a method of applying liquid such as water, etc. (for example, a method of immersing a laminated body obtained as mentioned above in a liquid, a method of blowing liquid, etc.), a method of applying vibration such as ultrasonic vibration, etc., can be exemplified. Further, two or more methods selected from the above can be combined. More concretely, a method of immersing in a liquid such as water, etc., after blowing gas such as air, etc., a method of applying ultrasonic vibration in a state immerged in a liquid such as water, etc., can be exemplified. Among other things, it is preferable to employ a method of applying a liquid such as water against the laminated body obtained as mentioned above (especially, a method of immersing in a liquid such as water).

In the above explanation, the explanation was directed to the case in which the formation of the bonded portion is performed using a bonding liquid. However, in the manufacturing method of the present invention, the formation of the bonded portion can be performed by any method, for example, by irradiating energy line to fuse (sinter, bond) the granular substances 111.

According to the manufacturing method of the present invention as mentioned above, a three-dimensional shaped object excellent in dimensional accuracy and effectively prevented in occurrence of defects can be manufactured effectively.

### Three-Dimensional Shaped Object Manufacturing Device

Next, a three-dimensional shaped object manufacturing device according to the present invention will be explained.

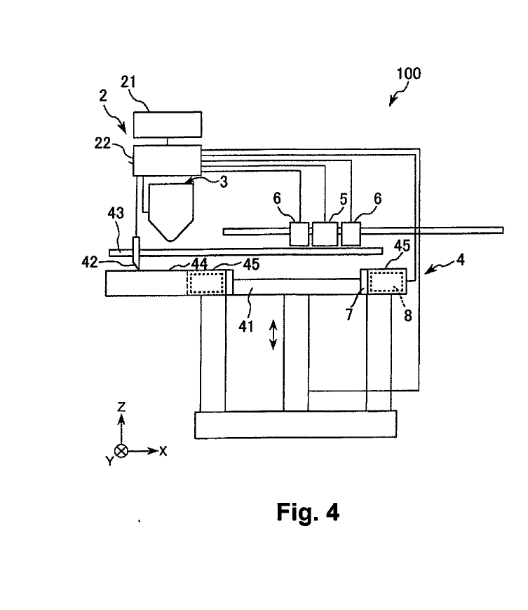

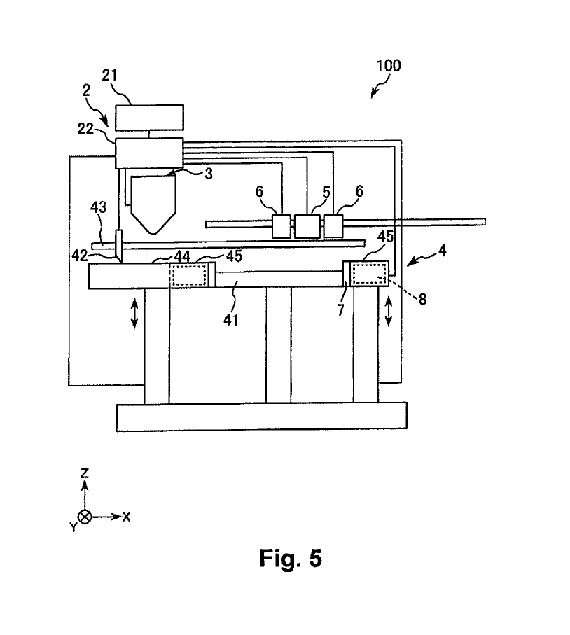

FIG. 4 is a cross-sectional view schematically showing a preferable embodiment of a three-dimensional shaped object manufacturing device according to the present invention. FIG. 5 is a cross-sectional view schematically showing another preferable embodiment of a three-dimensional shaped object manufacturing device according to the present invention.

The three-dimensional shaped object manufacturing device 100 manufactures a three-dimensional shaped object by repeatedly forming and laminating layers 1 using a pasty composition (three-dimensional shaping composition) 11 containing granular substances 111.

As shown in FIG. 4, the three-dimensional shaped object manufacturing device 100 is provided with a control section 2, a composition supply section 3 for accommodating a pasty composition 11 containing granular substances 111, a layer formation section 4 for forming a layer 1 using the composition 11 supplied form the composition supply section 3, a bonding liquid ejecting section (bonding liquid application unit) 5 for ejecting the bonding liquid 12 to the layer 1, and an energy line irradiation unit (curing unit) 6 for irradiating energy line to cure the bonding liquid 12 (this explanation is also applied to the three-dimensional shaped object manufacturing device 100 shown in FIG. 5).

The control section 2 includes a computer 21 and a drive control section 22. The computer 21 is a commonly-used desktop type computer, etc., equipped with CPUs, memories, etc., therein. The computer 21 converts a shape of a three-dimensional shaped object 10 into data as model data and outputs cross-sectional data (slice data) obtained by slicing the model data into a plurality of parallel thin cross-section layers to the drive control section 22.

The drive control section 22 functions as a unit for driving the layer formation section 4, the bonding liquid ejecting section 5, the energy line irradiation unit 6, and the heating unit 8, respectively. Specifically, for example, the drive control section controls the ejection pattern or ejection amount of the bonding liquid 12 by the bonding liquid ejecting section 5, the supplied amount of the composition 11 from the composition supply section 3, the downward movement amount of the stage 41, etc.

The composition supply section 3 is configured so as to move in accordance with the instruction from the drive control section 22 to supply the composition 11 accommodated therein to a composition temporarily holding section 44.

The layer formation section 4 is provided with a composition temporarily holding section 44 for temporarily holding the composition 11 supplied form the composition supply section 3, a squeegee (flattening unit) 42 for forming a layer 1 while flattening the composition 11 held by the composition temporarily holding section 44, a guide rail 43 for controlling the movement of the squeegee 42, a stage 41 for supporting the formed layer 1, and a side surface supporting section (frame) 45 surrounding the stage 41.

The stage 41 is sequentially lowered by a predetermined amount in accordance with the instruction from the drive control section 22 when forming a new layer 1 on a previously formed layer 1. By this lowered amount of the stage 41, the thickness of the layer 1 to be newly formed is defined.

Further, as shown in FIG. 4, since the stage 41 is constituted so as to be movable in the Z-direction (up and down direction), the number of parts to be moved to adjust the thickness of the layer 1 when forming a new layer 1 can be reduced. Accordingly, the structure of the three-dimensional shaped object manufacturing method 100 can be more simplified.

The stage 41 is flat in surface (portion to which the composition 11 is applied). With this, a layer 1 high in thickness evenness can be formed easily and assuredly.

The stage 41 is preferably constituted by a high strength material. As the component material of the stage 41, various kinds of metallic materials, such as stainless steel, etc., can be exemplified.

Further, the surface (portion to which the composition 11 is applied) of the stage 41 can be subjected to a surface treatment. With this, for example, it becomes possible to effectively prevent that the component material of the composition 11 or the component material of the bonding liquid 12 adheres to the stage 41, and/or becomes possible to attain stable manufacturing of a three-dimensional shaped object 10 for long periods of time by making the endurance of the stage 41 especially excellent. As the material used for the surface treatment of the surface of the stage 41, for example, a fluorine-based resin, such as polytetrafluoroethylene, etc., can be exemplified.

The squeegee 42 is formed into an elongated shape extending in the Y-direction, and is provided with a blade having a blade shape with a tapered lower tip end.

The length of the blade in the Y-direction is the same as or longer than the width (the length in the Y-direction) of the stage 41 (shaping region).

The side surface supporting section 45 has a function of supporting the side surface of the layer 1 formed on the stage 41. Further, it also has a function of defining the area of the layer 1 at the time of forming the layer 1.

On the surface (portion which comes into contact with the composition 11) of the side surface supporting section 45, as an adhesion preventing part, a liquid repellent film 7 is formed.

By providing the adhesion preventing part as mentioned above, it becomes possible to assuredly prevent occurrence of unintentional deformation (disorder) of the layer 1 due to the sliding resistance when the stage 41 moves in the Z-direction (in the up and down direction). Consequently, the three-dimensional shaped object 10 to be finally obtained can be made excellent in dimensional accuracy and effectively controlled in occurrence of defects. Further, it can be considered such that only the region where no layer disorder occurs is utilized for a three-dimensional shaped object without utilizing the region where layer disorder occurs. In such a case, the stage cannot be utilized effectively (usage area ratio deteriorates), resulting in deteriorated productivity of a three-dimensional shaped object. Further, it sometimes becomes impossible to perform manufacturing of a large sized three-dimensional shaped object. However, according to the present invention, occurrence of such problems can be prevented, and a three-dimensional shaped object can be manufactured effectively.

Especially, by providing the liquid repellent film 7 as the adhesion preventing part, the adhesion of the layer 1 to the side surface supporting section 45 can be effectively prevented, which assuredly prevents occurrence of unintentional deforms (disorder) of the layer 1. Further, with a relatively simple structure, the adhesion of the composition 11 (layer 1) to the surface of the side surface supporting section 45 can be assuredly prevented. Further, even in cases where the function of the adhesion preventing part is deteriorated by the repeated use of the three-dimensional shaped object manufacturing device 100, the adhesion preventing function can be restored easily and assuredly by subjecting the side surface supporting section 45 to a surface treatment.

As the component material of the liquid repellent film 7, for example, a functionalized coupling agent having a liquid repellent property, a resin material having a liquid repellent property, etc., can be exemplified.

As a coupling agent, for example, a silane-based coupling agent, a titanium-based coupling agent, an aluminum-based coupling agent, a zirconium-based coupling agent, an organic phosphoric acid-based coupling agent, a cyril peroxide-based coupling agent, etc., can be used.

As a functional group showing liquid repellency, for example, a fuoroalkyl group, an alkyl group, a vinyl group, an epoxy group, a styryl group, a methacryloxy group, etc., can be exemplified.

On the other hand, as a resin material having liquid repellency, for example, a fluorine-based resin, such as, polytetrafluoroethylene (PTFE), tetrafluoroethylene-perfluoroalkyl vinyl ether copolymer (PFA), ethylene-tetrafluoroethylene copolymer (ETFE), perfluoroethylene-propene copolymer (FEP), ethylene-chloro-trifluoro-ethylene copolymer (ECTFE), etc., can be exemplified. Among other things, as the component material of the liquid repellent film 7, a fluorine-based resin is preferable.

With this, the adhesion of the composition 11 (layer 1) to the surface of the side surface supporting section 45 can be prevented more effectively.

It is preferable that the thickness of the liquid repellent film 7 is 0.01 μm to 300 μm, more preferably 0.1 μm to 100 μm, still more preferably 1.0 μm to 70 μm.

With this, the function as the adhesion preventing part can be stably exerted for long periods of time while suppressing the cost increase.

It is preferable that the surface roughness Ra of the liquid repellent film 7 (the surface roughness Ra of the portion which comes into contact with the composition 11) is 0.1 μm to 30 μm, more preferably 0.5 μm to 20 μm.

With this, the adhesion of the composition 11 (layer 1) to the surface of the side surface supporting section 45 can be prevented more effectively.

Further, the three-dimensional shaped object manufacturing device 100 is provided with a heating unit 8 for heating the side surface supporting section 45 as an adhesion preventing part.

With this, the adhesion of the layer 1 to the side surface supporting section 45 can be prevented more effectively, which more assuredly can prevent occurrence of unintentional deforms (disorder) of the layer 1. Further, the heating temperature can be adjusted depending on the component material of the composition 11 (layer 1), the component material of the bonding liquid 12, the moving speed of the stage, etc. As a result, an appropriate adhesion preventing effect can be obtained while effectively suppressing unintentional denaturalization, deterioration, etc., of the component material of the composition 11 (layer 1) or the component material of the bonding liquid 12. Further, since the heating temperature is adjustable, it is possible to avoid more energy consumption than necessary to attain an appropriate adhesion preventing effect. This is preferable from a viewpoint of energy saving.

It is preferable that the heating temperature of the side surface supporting section 45 by the heating unit 8 is 40° C. to 90° C., more preferably 45° C. to 80° C.

With this, a more appropriate adhesion preventing effect can be obtained while more effectively preventing the unintentional denaturalization, deterioration, etc., of the component material of the composition 11 (layer 1) or the component material of the bonding liquid 12. Further, this is preferable from a viewpoint of energy saving.

In the illustrated structure, the heating unit 8 is provided inside the side surface supporting section. However, the installation position of the heating unit 8 is not specifically limited, and can be, for example, provided outside the side surface supporting section 45 to heat the side surface supporting section 45 by thermal conduction.

Further, the three-dimensional shaped object manufacturing device 100 can be provided with a vibration application unit (not illustrated) for applying vibration to the composition 11 (layer 1) formed in the shaping region as an adhesion preventing part.

With this, the adhesion of the layer 1 to the side surface supporting section 45 can be prevented more effectively, which more assuredly can prevent occurrence of unintentional deforms (disorder) of the layer 1.

Such a vibration application unit can apply vibration to the composition 11 (layer 1) during, for example, the moving process.

With this, the friction between the layer 1 and the side surface supporting section 45 during the moving process can be reduced, which assuredly can prevent occurrence of unintentional deforms (disorder) of the layer 1.

This is considered because of the following reasons. That is, by applying vibration to the composition 11 (layer 1) in the moving process, the granular substances 111, etc., constituting the layer 1 become in a minutely vibrating (moving) state. For this reason, the friction coefficient between the side surface supporting section 45 and the layer 1 at the time of initiating the movement of the stage 41 is not a coefficient of static friction but becomes close to a coefficient of dynamic friction. In general, since a coefficient of static friction is smaller than a coefficient of dynamic friction, occurrence of unintentional deform (disorder) of the layer 1 is prevented more effectively by the sliding resistance.

Further, the vibration applying unit can apply vibration to the composition 11 (layer 1) between, for example, from the formation of the layer 1 in the layer structuring process to the curing process of the layer 1.

This decreases the viscosity of the layer 1, effectively preventing the adhesion of the layer to the side surface supporting section 45, which more effectively prevents unintentional deform (disorder) of the layer 1.

As the types of vibration that the vibration applying unit applies, for example, ultrasonic vibration, etc., can be exemplified. The vibration applying unit can be configured to apply vibration to the entire layer 1 (the entire composition 11 formed in the shaping region), or can be configured to apply vibration to a partial region including at least the contact portion to the side surface supporting section 45 among the layer 1 (composition 11).

The bonding liquid application unit (bonding liquid ejecting section) 5 is configured to apply a bonding liquid 12 to the layer 1. By providing such a bonding liquid application unit 5, the three-dimensional shaped object 10 can be easily and assuredly made excellent in mechanical strength.

Especially, in this embodiment, the bonding liquid application unit 5 is a bonding liquid ejecting section for ejecting a bonding liquid 12 by an ink-jet method.

With this, the bonding liquid 12 can be applied with a fine pattern. Therefore, even in the case of a three-dimensional shaped object having a fine structure, the object can be manufactured especially with excellent productivity.

As a liquid drop ejection system (system of the ink-jet method), although a piezo system or a system of ejecting a bonding liquid 12 by foams (bubbles) generated by heating the bonding liquid 12, etc., can be used, it is preferable to use a piezo system from the viewpoint of the difficulty in transformation of the component element of the bonding liquid 12.

In the bonding liquid ejecting section (bonding liquid application unit) 5, the pattern to be formed in each layer 1 and the amount of the bonding liquid 12 to be applied to each portion of the layer 1 are controlled in accordance with the instruction from the drive control section 22. The ejection pattern, the ejection amount, etc., of the bonding liquid 12 by the bonding liquid ejecting section (bonding liquid application unit) 5 are determined based on the slice data.

The energy line irradiation unit (curing unit) 6 irradiates energy line for curing the bonding liquid 12 applied to the layer 1.

The type of energy line that the energy line irradiation unit 6 irradiates differs depending on the component material of the bonding liquid 12, but, for example, ultraviolet rays, visible rays, infrared rays, X-rays, gamma beams, electron beams, ion beams, etc., can be exemplified. Among other things, from the viewpoint of the cost, and the productivity of the three-dimensional shaped object, it is preferable to use ultraviolet rays.

Further, in the structure shown in FIG. 4, the stage 41 is movable in the Z-direction (in the up and down direction). On the other hand, in the structure shown in FIG. 5, it is structured that the side surface supporting section 45 is movable in the Z-direction (in the up and down direction). As explained above, in the present invention, it is enough that the stage and the side surface supporting section are relatively movable in the up and down direction.

Especially, as shown in FIG. 5, since the side surface supporting section 45 is structured so as to be movable in the Z-direction (in the up and down direction), even in cases where, for example, the area of the stage 41 is large or the weight of the three-dimensional shaped object 10 to be manufactured is heavy, a three-dimensional shaped object 10 can be preferably manufactured. Further, since unintentional vibration, etc., of the stage 41 is effectively prevented, it is more advantageous from the viewpoint of further improving the dimensional accuracy.

As shown in FIG. 5, in the case in which the side surface supporting section 45 is movable in the Z-direction (in the up and down direction), when forming a new layer 1 on the previously formed layer 1, the side surface supporting section 45 is sequentially raised by a predetermined amount in accordance with the instruction from the drive control section 22. By the raised amount of the side surface supporting section 45, the thickness of the layer 1 to be newly formed is defined.

According to the above explanation, the three-dimensional shaped object manufacturing device is provided with the bonding liquid ejecting section (bonding liquid application unit) and the energy line irradiation unit (curing unit), and the cured portion (bonded portion) is formed by the device. The three-dimensional shaped object manufacturing device of the present invention is not limited to the device having the aforementioned structure as a unit for forming a bonded portion. The device can be a device equipped with, for example, an energy line irradiation unit for irradiating energy line for fusing (sintering, bonding) the granular substances, in place of the bonding liquid ejecting section (bonding liquid application unit) and the energy line irradiation unit (curing unit).

In the case in which the three-dimensional shaped object manufacturing device is equipped with an energy line irradiation unit for irradiating energy line for fusing (sintering, bonding) the granular substances, the energy line irradiation unit is controlled in pattern (irradiation pattern of energy line) to be formed in each layer 1 and the energy amount of the energy line irradiated in each portion of the layer 1 in accordance with the instruction from the drive control section 22. The irradiation pattern, the energy amount, etc., of the energy line by the energy line irradiation unit are determined based on the slice data.

According to the three-dimensional shaped object manufacturing device of the present invention as mentioned above, a three-dimensional shaped object excellent in dimensional accuracy and effectively prevented in occurrence of defects can be manufactured effectively.

### Composition (Three-Dimensional Shaping Composition)

Next, the composition (Three-dimensional shaping composition) 11 for use in manufacturing a three-dimensional shaped object according to the present invention will be explained.

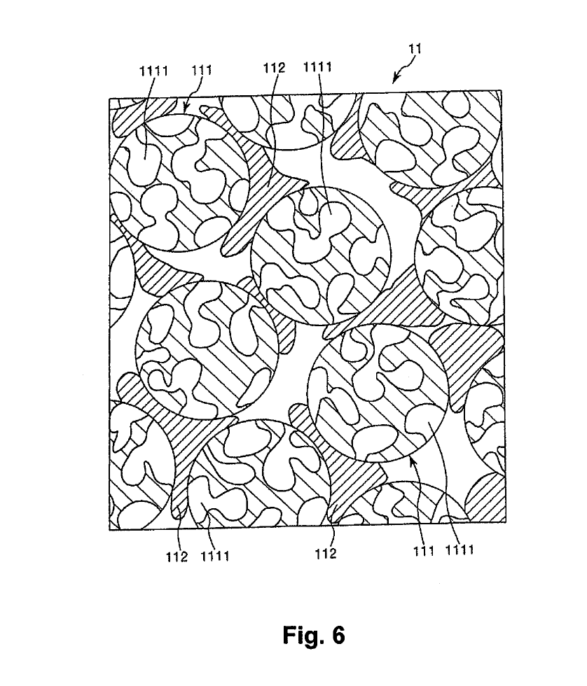

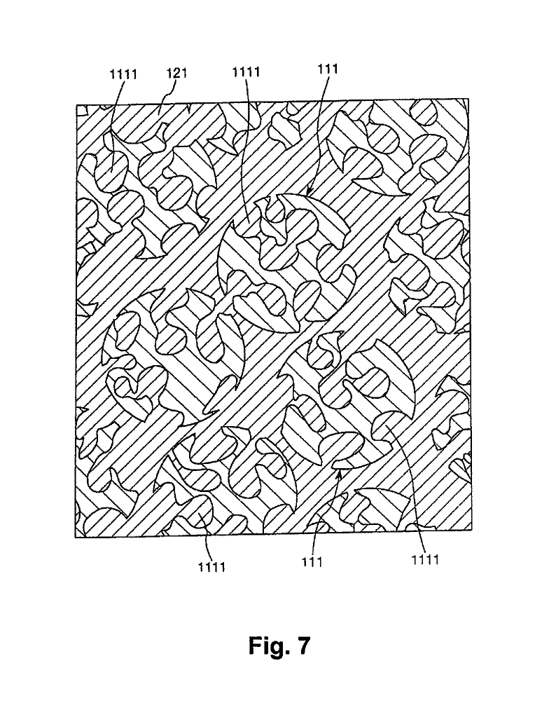

FIG. 6 is a cross-sectional view schematically showing a state in a layer (three-dimensional shaping composition) immediately before a bonding liquid application process. FIG. 7 is a cross-sectional view schematically a state in which granular materials are bonded by a hydrophobic bonding agent.

The composition (three-dimensional shaping composition) 11 includes at least a three-dimensional shaping powder containing a plurality of granular substances 111 and is in a paste state.

### Powder for Three-Dimensional Shaped Object (Granular Substance 111)

It is preferable that the granular substance 111 constituting the three-dimensional shaping powder is porous and subjected to a hydrophobic treatment. With this structure, in the case in which the bonding liquid 12 includes a hydrophobic bonding agent 121, it becomes possible to force the hydrophobic bonding agent 121 into the hole 1111 when producing a three-dimensional shaped object 10, which exerts the anchor effect. As a result, the bonding force (bonding force via the bonding agent 121) for bonding granular substances 111 can be made excellent. This in turn can preferably manufacture a three-dimensional shaped object 10 excellent in mechanical strength (see FIG. 7). Further, such a three-dimensional shaping powder can be preferably reused. In detail, when the granular substance 111 constituting the three-dimensional shaping powder is a powder subjected to a hydrophobic treatment, since a water-soluble resin 112 which will be detailed later is prevented from entering in the hole 1111, in producing a three-dimensional shaped object 10, the granular substances 111 in the region where no bonding liquid 12 was applied can be collected with low impurity content and high purity by washing with water, etc. For this reason, again by mixing the collected three-dimensional shaping powder with a water-soluble resin 112, etc., at a predetermined rate, a three-dimensional shaping composition assuredly controlled into a desired composition can be obtained. Further, the bonding agent 121 constituting the bonding liquid 12 is entered in the hole 1111 of the granular substance 111, which can effectively prevent unintentional wet spreading of the bonding liquid 12. As a result, the three-dimensional shaped object 10 to be finally obtained can be made especially high in dimensional accuracy.

As a component material of the granular substance 111 constituting the three-dimensional shaping powder (mother particles to which a hydrophobic treatment is subjected), for example, an inorganic material, an organic material, these complexes, etc., can be exemplified.

As the inorganic material constituting the granular substance 111, for example, various metals, metal compounds, etc., can be exemplified. As the metal compound, for example, various metal oxides such as silica, alumina, titanium oxide, zinc oxide, zircon oxide, tin oxide, magnesium oxide, potassium titanate, etc.; various metal hydroxides such as magnesium hydroxide, aluminum hydroxide, calcium hydroxide, etc.; various metal nitride such as silicone nitride, titanium nitride, aluminum nitride, etc.; various metal carbide such as silicon carbide, titanium carbide, etc.; various metal sulfide such as zinc sulfide, etc.; various metal carbonate such as calcium carbonate, magnesium carbonate, etc.; various hydrosulfate of metal such as calcium sulfate, magnesium sulfate; various silicates of metal such as calcium silicate, magnesium silicate, etc.; various phosphate of metal such as calcium phosphate, etc.; various borates of metal such as aluminum borate, magnesium borate, etc.; or these compounds are exemplified.

As the organic material constituting the granular substance 111, for example, synthetic resin, natural polymer, etc., can be exemplified. More specifically, polyethylene resin; polypropylene; polyethylene oxide; polypropylene oxide, polyethylenimine; polystyrene; polyurethane; polyurea; polyester; silicone resin; acrylic silicone resin; polymers in which (meta) acrylic acid ester is a constitution monomer such as polymethylmethacrylate, cross polymer (ethylene acrylic acid copolymer resin in which (meta) acrylic acid ester is a constitution monomer such as methyl methacrylate crosspolymer, polyamide resin such as nylon 12, nylon 6, copolymer nylon, etc., polyimide; carboxymethyl cellulose; gelatin; starch; chitin; chitosan; etc., can be exemplified.

Among other things, the granular substance 111 is preferably formed by inorganic materials, more preferably formed by metal oxide, still more preferably formed by silica. This makes the property of the three-dimensional shaped object 10 such as mechanical strength, light resistance especially excellent. Further, when the granular substance 111 is made of silica, the aforementioned effect can be exerted more significantly. Further, since silica is also excellent in fluidity, it is advantageous to form a layer 1 more excellent in thickness evenness, and also advantageous to make the productivity and dimensional accuracy of a three-dimensional shaped object 10 especially excellent.

As the hydrophobic treatment subjected to the granular substance 111 constituting the three-dimensional shaping powder, although any treatments for enhancing the hydrophobic of the granular substance 111 (mother particle) can be employed, a treatment for introducing hydrocarbon group is preferable. This enhances the hydrophobic of the granular substance 111. Further, this easily and assuredly makes the evenness of the degree of the hydrophobic treatment at each granular substance 111 or each portion (including the surface of the inside of the hole 1111) of the surface of each granular substance 111 more higher.

As a compound used for the hydrophobic treatment, a silane compound including a silyl group is preferred. As a specific example of the compounds that can be used for the hydrophobic treatment, for example, the followings are exemplified: hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanatepropyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyroxysilane, di-sec-butyldi-sec-butyroxysilane, di-t-butyldi-t-butyroxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyltri-n-propoxysilane, methylisopropoxysilane, methyl-n-butyroxysilane, methyltri-sec-butyroxysilane, methyltri-t-butyroxysilane, ethyltrimethoxysilane, ethyltriethoxysilane, ethyltri-n-propoxysilane, ethylisopropoxysilane, ethyl-n-butyroxysilane, ethyltri-sec-butyroxysilane, ethyltri-t-butyroxysilane, n-propyltrimethoxysilane, isobutyl trimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysilane, 2-[2-(trichlorosilyl)ethyl]pyridine, 4-[2-(trichlorosilyl)ethyl]pyridine, diphenyldimethoxysilane, diphenyldiethoxysilane, 1,3-(trichlorosilyl methyl)heptacosane, dibenzyldimethoxysilane, dibenzyldiethoxysilane, phenyltrimethoxysilane, phenylmethydimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzylethoxysilane, 3-acetoxypropyl-trimethoxysi lane, 3-acryloxypropyl-trimethoxysilane, allyltrimethoxysilane, allyltriethoxysilane, 4-amino-butyl triethoxysilane, (aminoethyl aminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexyl aminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, aminoundecyltrimethoxysilane, amyltriethoxysilane, benzooxasilepindimethylester, 5-(bicycloheptenyl)triethoxysilane, bis(2-hydroxyethyl)-3-aminopropyltriethoxysilane, 8-bromo-octyltrimethoxysilane, bromophenyltrimethoxysilane, 3-bromo-propyltrimethoxysilane, n-butyltrimethoxysilane, 2-chloro-methyltriethoxysilane, chloromethylmethyldiethoxysilane, chloromethylmethyldiisopropoxysilan, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chloro-sulfonylphenyl)ethyltrimethoxysilane, 2-cyano-ethyltriethoxysilane, 2-cyano-ethyltrimethoxysilane, cyanomethylphenethyltriethoxysilane, 3-cyano-propyltriethoxysilane, 2-(3-cyclohexenyl)ethyltrimethoxysilane, 2-(3-cyclohexenyl)ethyl triethoxysilane, 3-cyclohexenyltrichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexyl methyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-ene, 3-(2,4-dinitrophenylamino)propyl triethoxysilane, dimethylchlorosilyl)methyl-7,7-dimethylnorpinane, (cyclohexyl aminomethyl)methyldiethoxysilane, (3-cyclopentadienyl propyl)triethoxysilane, N,N-diethyl-3-aminopropyl)trimethoxysilane, 2-(3,4-epoxy cyclohexyl)ethyltrimethoxysilane, 2-(3,4-epoxy cyclohexyl)ethyltriethoxysilane, (furfuryl oxymethyl)triethoxysilane, 2-hydroxy-4-(3-ethoxy propoxy)diphenylketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 2,3,4,7,7,-hexachloro-6-methyldiethoxysilyl-2-norbornene, 1,2,3,4,7,7,-hexachloro-6-triethoxysilyl-2-norbornene, 3-iodopropyltrimethoxysilane, 3-isocyanatepropyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl {2-(3-trimethoxysilyl propyl-amino)ethylamino}-3-propionate, 7-octenyltrimethoxysilane, R—N-α-phenethyl-N′-triethoxysilylpropylurea, S—N-α-phenethyl-N′-triethoxysilylpropylurea, phenethyl trimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltrimethoxysilane, (3-phenylpropyl)dimethylchlorosilane, (3-phenylpropyl)methyldichlorosilane, N-phenylaminopropyltrimethoxysilane, N-(triethoxysilyl propyl)dansylamide, N-(3-triethoxysilylpropyl)-4,5-dihydro-imidazole, 2-(triethoxysilylethyl)-5-(chloroacetoxymethyl)bicycloheptane, (S)—N-triethoxysilylpropyl-O-mentcarbamate, 3-(triethoxysilylpropyl)-p-nitrobenzamide, 3-(triethoxysilyl)propylsuccinate anhydride, N-[5-(trimethoxysilyl)-2-aza-1-oxo-pentyl]caprolactam, 2-(trimethoxysilylethyl)pyridine, N-(trimethoxysilylethyl)benzyl-N,N,N-trimethylammoniumchloride, phenylvinyldiethoxysilane, 3-thiocyanate-propyltriethoxysilane, (toridecafluoro1,1,2,2,-tetrahydro-octyl)triethoxysilane, N-{3-(triethoxysilyl)propyl}phthalamic acid, (3,3,3-trifluoro-propyl)methyldimethoxysilane, (3,3,3-trifluoro-propyl)trimethoxysilane, 1-trimethoxysilyl-2-(chloromethyl)phenylethane, 2-(trimethoxysilyl)ethylphenylsulfonylazide, β-trimethoxysilylethyl-2-pyridine, trimethoxysilylpropyldiethylenetriamine, N-(3-trimethoxysilylpropyl)pyrrole, N-trimethoxysilylpropyl-N,N,N-tributylammoniumbromide, N-trimethoxysilylpropyl-N,N,N-tributylammoniumchloride, N-trimethoxysilylpropyl-N,N,N-trimethylammoniumchloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyl trichlorosilane, (aminoethylaminomethyl)phenethyltrimethoxysilane, 3-aminophenoxydimethylvinylsilane, phenyltrichlorosilane, phenyldimethyl chlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyano-ethyltrichlorosilane, 2-cyanoethylmethyldichlorosilane, 3-cyanopropylmethyldiethoxysilane, 3-cyanopropylmethyldichlorosi lane, 3-cyanopropylmethyldichlorosilane, 3-cyano-propyldimethylethoxysilane, 3-cyanopropylmethyldichlorosilane, 3-cyanopropyltrichlorosilane, fluorinated alkylsilane, etc., and it can be used by combining one or more selected from these compounds.

Among other things, it is preferable to use the hexamethyldisilazane for the hydrophobic treatment. This further enhances the hydrophobic of the granular substance 111. Further, this easily and assuredly makes the evenness of the degree of the hydrophobic treatment at each granular substance 111 or each portion (including the surface of the inside of the hole 1111) of the surface of each granular substance 111 more higher.

In cases where the hydrophobic treatment using a silane compound is performed in a liquid phase, a desired reaction can be proceeded preferably by immersing the granular substances 111 (mother particles) to be subjected to the hydrophobic treatment in a liquid containing a silane compound, which enables to form a chemical absorption film of a silane compound.

Further, in cases where the hydrophobic treatment using a silane compound is performed in a gas phase, a desired reaction can be proceeded preferably by exposing the granular substances 111 (mother particles) to be subjected to the hydrophobic treatment to a vapor of the silane compound, which enables to form a chemical absorption film of a silane compound.

Although the average particle diameter of the granular substance 111 constituting the three-dimensional shaping powder is not specifically limited, it is preferable that the average particle diameter is 1 μm to 25 μm, more preferably 1 μm to 15 μm. With this, the mechanical strength of the three-dimensional shaped object 10 can be made especially excellent, and occurrence of unintentional unevenness, etc., of the three-dimensional shaped object 10 to be manufactured can be more effectively prevented, which enables to make the dimensional accuracy of the three-dimensional shaped object 10 especially excellent. Further, the fluidity of the three-dimensional shaping powder and the fluidity of the pasty composition (three-dimensional shaping composition) 11 including the three-dimensional shaping powder can be made especially excellent, which enables to make the productivity of a three-dimensional shaped object 10 especially excellent.

In the present invention, the average particle diameter denotes an average particle diameter on a volume basis, and can be obtained, for example, by measuring a dispersion liquid obtained by adding a sample to methanol and dispersed with an ultrasonic dispersion device for 3 minutes using an aperture of 50 μm by a Coulter counter method particle size distribution measuring instrument (made by COULTER ELECTRONICS INS TA-II type).

The Dmax (maximum diameter) of the granular substance 111 constituting the three-dimensional shaping powder is preferably 3 μm to 40 μm, more preferably 5 μm to 30 μm. With this, the mechanical strength of the three-dimensional shaped object 10 can be made especially excellent, and occurrence of unintentional unevenness, etc., of the three-dimensional shaped object 10 to be manufactured can be more effectively prevented, which enables to make the dimensional accuracy of the three-dimensional shaped object 10 especially excellent. Further, the fluidity of the three-dimensional shaping powder and the fluidity of the pasty composition (three-dimensional shaping composition) 11 including three-dimensional shaping powder can be made especially excellent, which enables to make the productivity of a three-dimensional shaped object 10 especially excellent.

The hole rate of the granular substance 111 constituting the three-dimensional shaping powder is preferably 50% or more, more preferably 55% to 90%. This results in a granular substance which has sufficient spaces (holes 1111) into which bonding agent enters and is excellent in mechanical strength of the granular substance 111 itself. As a result, the three-dimensional shaped object 10 in which bonding agent 121 is entered in the holes 1111 can be made especially excellent in mechanical strength. In the present invention, the hole rate of the granular substance (particle) denotes a ratio (volume ratio) of the hole existing inside the granular substance to the apparent volume of the granular substance, which is a value expressed by, {(ρ₀−ρ₀}×100, where the density of the granular substance is ρ(g/cm³), and the real density of the component material of the granular substance is ρ₀(g/cm³).

The average hole diameter (pore diameter) of the granular substance 111 is preferably 10 nm or more, more preferably 50 nm to 300 nm. This makes the three-dimensional shaped object 10 to be finally obtained especially excellent in mechanical strength. Further, in the case of using a bonding liquid 12 (colored ink) containing a pigment in producing a three-dimensional shaped object 10, it is possible to appropriately hold the pigment in the holes 1111 of the granular substance 111. For this reason, the unintentional diffusion of the pigment can be prevented, which enables to more assuredly form a high resolution image.

Although the granular substance 111 constituting the three-dimensional shaping powder can be any shape, the granular substance is preferably in a spherical configuration. With this, the fluidity of the three-dimensional shaping powder and the fluidity of the pasty composition (three-dimensional shaping composition) 11 including the three-dimensional shaping powder can be made especially excellent, which enables to make the productivity of a three-dimensional shaped object 10 especially excellent. At the same time, occurrence of unintentional unevenness, etc., of the three-dimensional shaped object 10 to be manufactured is more effectively prevented, which enables to make the dimensional accuracy of the three-dimensional shaped object 10 especially excellent.

The porosity of the three-dimensional shaping powder is preferably 70% to 98%, more preferably 75% to 97.7%. This makes the three-dimensional shaped object 10 especially excellent in mechanical strength. Further, the fluidity of the three-dimensional shaping powder and the fluidity of the pasty composition (three-dimensional shaping composition three-dimensional shaping composition) 11 including the three-dimensional shaping powder can be made especially excellent, which enables to make the productivity of a three-dimensional shaped object 10 especially excellent. This makes the productivity of the three-dimensional shaped object 10 sufficiently excellent and effectively prevents occurrence of unintentional unevenness, etc., of the three-dimensional shaped object 10, which enables to make the dimensional accuracy of the three-dimensional shaped object 10 especially excellent. In the present invention, the porosity of the three-dimensional shaping powder denotes a ratio of a sum of the volume of the holes of the entire granular substances (particles) constituting the three-dimensional shaping powder and the volume of the gap existing between the granular substances (particles) to the volume of a container in the case in which the container of a predetermined volume (e.g., 100 mL) is filled with three-dimensional shaping powder, and is represented by {(P₀−P)/P₀}×100, where a bulk density of the three-dimensional shaping powder is P (g/cm³), and the true density of the component material of the three-dimensional shaping powder is P₀ (g/cm³).

The content rate of the three-dimensional shaping powder in the component (three-dimensional shaping composition) is preferably 10 mass % to 90 mass %, more preferably 15 mass % to 65 mass %. This makes the fluidity of the composition (three-dimensional shaping composition) 11 sufficiently excellent and also makes the mechanical strength of the three-dimensional shaped object 10 especially excellent.

### Water-Soluble Resin

The composition 11 can include water-soluble resin 112 together with a plurality of granular substances 111.

Containing the water-soluble resin 112 bonds (temporarily secured) the granular substances 111 each other at the position where no bonding liquid 12 is applied (see FIG. 6), which effectively prevents unintentional scattering, etc., of the granular substances 111. This enables to attain the safety of the operator and the further improvement of the dimensional accuracy of the three-dimensional shaped object 10 to be manufactured.

In the case in which the water-soluble resin is contained, the aforementioned effects can be obtained. On the other hand, the granular substance constituting the layer on the stage is temporarily fixed by the water-soluble resin even in the region where no bonded portion (cured portion) is formed. Therefore, when applied to a conventional structure, there is a problem that a layer disorder due to the sliding resistance readily causes not only at the vicinity of the contact portion to the side surface supporting section but also in a wider range. On the other hand, in the present invention, since the adhesion preventing part is provided, the occurrence of such problem can be prevented assuredly. Therefore, in cases where the composition includes a water-soluble resin, the effects of the present invention can be exerted more notably.

Further, even in the case in which the water-soluble resin 112 is contained, when the granular substances 111 were subjected to a hydrophobic treatment, it is effectively prevented that the water-soluble resin 112 enters in the holes 1111 of the granular substance 111. For this reason, the function of the water-soluble resin 112 for temporary fixing the granular substances 111 each other can be exerted assuredly, and it is possible to assuredly prevent occurrence of the problem that the water-soluble resin 112 previously enters in the holes 1111 of the granular substance, which prevents securing a space into which a bonding agent 121 enters.

The water-soluble resin 112 is not specifically limited as long as at least the part of the water-soluble resin is water-soluble. For example, it is preferable that the solubility (soluble mass per water of 100 g) to water at 25° C. is equal to or more than 5 (g/water of 100 g), more preferably equal to or more than 10 (g/water of 100 g).

As the water-soluble resin 112, for example, the followings are exemplified: synthetic polymers such as polyvinyl alcohol (PVA), polyvinylpyrrolidone (PVP), polycaprolactam diol, sodium polyacrylate, polyacrylamide, modified polyamide, polyethylenimine, polyethylene oxide, random copolymer of ethylene oxide and propylene oxide, etc., natural polymers such as cornstarch, mannan, pectin, agar, alginic acid, dextran, glue, gelatin, etc., semi-synthetic polymers such as carboxymethyl cellulose, hydroxyethyl cellulose, oxidized starch, modified starches, etc. One or more selected from the above can be used in combination.

As an example of a water-soluble resin product, for example, the followings are exemplified: methylcellulose (trade name “METOLOSE SM-15” made by Shin-Etsu Chemical Co., Ltd.), hydroxyethylcellulose (trade name “AL-15” made by Fuji Chemical Co., Ltd), hydroxypropyl cellulose (trade name “HPC-M” mad by Nippon Soda Co., Ltd.), carboxymethylcellulose (trade name “CMC-30” made by Nichirin Chemical Co., Ltd.), sodium starch phosphate ester (trade name “HOSUTA 5100” made by Matsutani Chemical Industry Co., Ltd.), polyvinylpyrroidone (trade name “PVP K-90” made by Tokyo Chemicaly Industry Co., Ltd.), methylvinylether/maleic anhydride copolymer (trade name “AN-139” made by GAF Gauntlet Co., Ltd.), polyacrylamide (Wako Pure Chemical Industries, Ltd.), modified polyamide (modified nylon)(trade name “AQ NYLON” made by Toray Industries, Inc.), polyethylene oxide (trade name “PEO-1” made by Steel Chemical Co., Ltd., trade name “Al Cox” made by Meisei Chemical Industry Co., Ltd.), ethylene oxide/propylene oxide random copolymer (trade name “Al Cox EP” made by Meisei Chemical Industry Co., Ltd.), sodium polyacrylate (Wako Pure Chemical Industries, Ltd.), carboxy vinyl polymer/cross-linked acrylic water-soluble resin (trade name “AQUPEC” made by Sumitomo Seika Chemicals Co., Ltd.), etc.

Among such products, when the water-soluble resin 112 is polyvinyl alcohol, the mechanical strength of the three-dimensional shaped object 1 can be particularly excellent. Also, by adjusting saponification or degree of polymerization, the properties of the water-soluble resin 112 (e.g., water solubility, water resistance, etc.) or the properties of the composition 11 (e.g., viscosity, fixing force of the granular substances 111, wettability, etc.) can be appropriately controlled. Therefore, it can be appropriately attained by various manufacturing methods of the three-dimensional shaped object 1. Further, among the various water-soluble resins, polyvinyl alcohol is low cost and has the supply stability. Therefore, the manufacturing cost is suppressed and the three-dimensional shaped object 10 can be stably manufactured.

When the water-soluble resin 112 includes polyvinyl alcohol, the saponification of polyvinyl alcohol is preferably equal to or more than 85 and equal to or less than 90. Therefore, the solubility of polyvinyl alcohol to the water can be suppressed. Therefore, when the composition 1 includes water, deterioration of the adhesiveness between the adjacent unit layers 1 can be effectively suppressed.

When the water-soluble resin 112 includes polyvinyl alcohol, the degree of the polymerization of polyvinyl alcohol is preferably equal to or more than 300 and equal to or less than 1,000. Therefore, when the composition 11 includes water, the mechanical strength of each layer 1 or the adhesiveness between the adjacent layers 1 can be made particularly excellent.

When the water-soluble resin 112 is polyvinylpyrroidone (PVP), the following effects are obtained. That is, polyvinylpyrroidone is excellent in adhesiveness to various materials such as glass, metals, plastics, etc., so that the strength and the shape stability in the part of layer where the bonding liquid 12 is not applied are particularly excellent, and the dimensional accuracy of the finally obtained three-dimensional shaped object 10 can be made particularly excellent. Further, polyvinylpyrroidone has high-solubility to various organic solvents, and therefore in cases where the composition 11 includes an organic solvent, the fluidity of the composition 11 can be made particularly excellent, and the layers 1 in which unintentional uneven thickness is effectively prevented can be appropriately formed, and the dimensional accuracy of the finally obtained three-dimensional shaped object 10 can be particularly excellent. Also, in the unattached particle removal process (after the object formation was completed), polyvinylpyrroidone has high-solubility to water, and therefore among the particles 111 constituting each layer 1, the particles that are not bonded by the bonding agent 121 can be easily and surely removed. Further, polyvinylpyrroidone has appropriate affinity with the three-dimensional shaping powder, and therefore it hardly penetrates inside the aforementioned holes 1111, and on the other hand, the wettability to the surface of the particles 111 is relatively high. Therefore, the aforementioned temporarily fixing function can be more effectively demonstrated. Also, polyvinylpyrroidone has excellent affinity with various coloring agents, and therefore when the bonding liquid 12 including the coloring agent are used in the ink application process, it can effectively prevent the coloring agent from spreading unexpectedly. Further, when the pasty composition 11 includes polyvinylpyrroidone, it can effectively prevent bubbles from mixing into the composition 11, and in the layer forming process, it can effectively prevent defects from occurring due to mixing the bubbles.

When the water-soluble resin 112 includes polyvinylpyrroidone, the weight-average molecular weight of polyvinylpyrroidone is preferably 10,000 to 1,700,000, and more preferably, 30,000 to 1,500,000. This demonstrates the aforementioned function more effectively.

Further, when the water-soluble resin 112 is polycaprolactam diol, the composition can be appropriately made into a pellet shape, and unintentional scattering, etc., of the granular substance 111 can be more effectively prevented, which enhances the operability (easiness of handling) of the composition 11. This enables to improve the safety of the operator and the dimensional accuracy of the three-dimensional shaped object 10 to be produced. Further, since the composition can be melted at relatively low temperatures, the energy and cost for producing the three-dimensional shaped object 10 can be reduced, and therefore, the productivity of the three-dimensional shaped object 10 can be made sufficiently excellent.

When the water-soluble resin 112 includes polycaprolactam diol, the weight-average molecular weight of the polycaprolactam diol is preferably 10,000 to 1,700,000, and more preferably; 30,000 to 1,500,000. Therefore, the aforementioned function can be more effectively demonstrated.

In the composition 11, it is preferable that the water-soluble resin 112, at least in the layer forming process, is in a liquid state (for example, a dissolved state, molten state, etc.). With this, the uniformity in the thickness of the layer 1 formed using the composition 11 can be easily and assuredly more enhanced.

### Solvent

The composition 11 can include a volatile solvent (not illustrated in FIG. 6) in addition to the aforementioned components.

With this, the composition 11 can be appropriately made into a pasty form, and the fluidity of the composition 11 can be stably made excellent, and the productivity of the three-dimensional shaped object 10 can be made particularly excellent. That is for the following reason. That is, in the present invention, at the time for forming the bonded portion (bonding liquid application process, curing process), in view of the stability of the shape of the layer and to prevent unintentional wet spreading of the coupling liquid, it is preferable to decrease the fluidity of the layer formed using the composition, but in a case in which the composition includes a solvent, the fluidity of the layer can be decreased by removing (volatilizing) the solvent. On the other hand, for example, at the time of forming the layer, in a case in which the component included in the composition is to be melted, to decrease the fluidity of the layer formed using the composition, the temperature of the composition (layer) is required to be decreased. But generally, an adjustment of the fluidity by removal of the solvent can be performed easily and quickly than an adjustment of the fluidity by such an adjustment of the temperature. Further, in the adjustment of the fluidity by the adjustment of the temperature, the fluidity of the layer fluctuates relatively widely by temperature, making it difficult to control the fluidity of the layer stably, but when performed by removing the solvent, the fluidity of the layer can be controlled stably. Further, when the component included in the composition is melted, the heating and cooling of the composition is required to be performed repeatedly, which requires a relatively large amount of energy. On the other hand, when a solvent is used, the amount of energy used can be controlled. Therefore, in view of saving energy, it is preferable to use a solvent.

It is preferable that the solvent is a solvent that melts the water-soluble resin 112. With this, the fluidity of the composition 11 can be made excellent, and unintentional uneven thickness of the layers 1 formed by using the composition 11 can be effectively prevented. Further, when forming the layers 1 in a state in which solvent is removed, along the entire layer 1, the water-soluble resin 112 can be adhered to the granular substances 111 with higher uniformity and unintentional unevenness of compositions can be effectively prevented from occurring. Therefore, occurrences of unintentional variations in the mechanical strength for each member of the three-dimensional shaped object 10 to be finally obtained can be effectively prevented, thereby further enhancing the reliability of the three-dimensional shaped object 10. Further, in the configuration shown in FIG. 6, a solvent is not illustrated, and the water-soluble resin 112 is illustrated so as to exist in a manner in which it is adhered to a portion of the outer surface of the granular substance 111 in an extracted manner. However, when a solvent is included, for example, the water-soluble resin 112 is included in the composition 11 in a state in which it is dissolved in the solvent, and the solution can exist in a manner in which it wets the surface of the granular substance 111 (for example, the surface other than the hole 1111 of the granular substance 111).

As a solvent constituting the composition 11, for example, water; alcohol solvents such as methanol, ethanol, isopropanol, etc.; ketone solvents such as methyl ethyl ketone, acetone, etc.; glycol ether series solvents such as ethylene glycol monoethyl ether, ethylene glycol monobutyl ether, etc.; glycol ether acetate-based solvents such as propylene glycol 1-monomethyl ether 2-acetate, propylene glycol 1-monoethylether 2-acetate, etc.; polyethylene glycol, polypropylene glycol, etc., can be exemplified, and one or more selected from these solvents can be combined and used.

Among them, the composition 11 preferably includes water. With this, the water-soluble resin 112 can be more assuredly dissolved, and the fluidity of the composition 11 and the uniformity of the composition of the layer 1 formed using the composition 11 can be made particularly excellent. Further, water can be easily removed after formation of the layers 1, and hardly exerts an adverse effect even in cases where it is remained in the three-dimensional shaped object 10. Also, it has advantage from the viewpoint of safety for the operator and environmental problems.

When the composition 11 includes a solvent, the content rate of the solvent in the composition 11 is preferably 5 mass % to 75 mass %, and more preferably 35 mass % to 70 mass %. With this, the effects due to the fact that the aforementioned solvent is included can be more prominently demonstrated and the solvent can be easily removed in a short amount of time during the manufacturing process of the three-dimensional shaped object 10. Therefore, it is advantageous from the viewpoint of productivity of the three-dimensional shaped object 10.

Especially in cases where the composition 11 includes water as a solvent, the content ratio of water in the composition 11 is preferably 20 mass % to 73 mass %, and more preferably 50 mass % to 70 mass %. With this, the aforementioned effects are more remarkably demonstrated.

### Other Components

Further, the composition 11 may include components other than the aforementioned components. As such components, for example, polymerization initiator, polymerization accelerator, penetration enhancer, wetting agent (humectant), fixing agent, antifungal agent, preservative, antioxidant, ultraviolet absorber, chelating agent, pH adjuster, etc., can be exemplified.

### Bonding Liquid

Next, the bonding liquid for use in manufacturing a three-dimensional shaped object according to the present invention will be explained. The bonding liquid 12 includes at least a bonding agent 121.

### Bonding Agent

Although the bonding agent 121 can be any bonding agent having a function to bind granular substances 111, in a case in which a granular substance having a hole 1111 and subjected to a hydrophobic treatment as described later as the granular substance 111, it is preferable that the agent is hydrophobic (lipophilic). With this, the affinity of the bonding liquid 12 and the granular substance 111 subjected to a hydrophobic treatment can be made higher, and since the bonding liquid 12 is applied to the layer 1, the bonding liquid 12 can appropriately penetrate inside the holes 1111 of the granular substances 111 subjected to a hydrophobic treatment. As a result, the anchor effect by the bonding agent 121 is appropriately demonstrated, and the mechanical strength of the three-dimensional shaped object 10 to be finally obtained can be made particularly excellent. In addition, the hydrophobic bonding agent can be any hydrophobic bonding agent having sufficiently low affinity with respect to water, but it is preferable that, for example, the solubility to water at 25° C. is 1 (g/100 g water) or less.

As the bonding agent 121, for example, thermoplastic resin; thermosetting resin; various light curable resins such as visible light curable resin which is cured by light in a visible light region (narrowly-defined light curable resin), ultraviolet curable resin, infrared curable resin, etc.; X-ray curable resin, etc., can be exemplified. Further, one or more selected from the above can be combined. Among them, in view of the mechanical strength of the three-dimensional shaped object 10 to be obtained and the productivity of the three-dimensional shaped object 10, it is preferable that the bonding agent 121 includes curable resin. Further, among the various curable resins, in view of the mechanical strength of the three-dimensional shaped object 10 to be obtained, the productivity of the three-dimensional shaped object 10, the storage stability of the bonding liquid 12, etc., an ultraviolet curable resin (polymerizable compound) is especially preferred.

As the ultraviolet curable resin (polymerizable compound), it is preferable to use the resin producing a polymer by starting addition-polymerization or ring-opening polymerization by radical species or cationic species produced from the photopolymerization initiator by emitting the ultraviolet light. As a polymerization method of addition polymerization, radical, cation, anion, metathesis, and coordination polymerization can be exemplified. Further, as a polymerization method of the ring-open polymerization, cation, anion, metathesis, and coordination polymerization can be exemplified.

As an addition-polymerizable compound, for example, a compound having at least one ethylenically unsaturated double bond, etc., can be exemplified. As the addition-polymerizable compound, a compound having at least one terminal ethylenically unsaturated bond, or preferably two terminal ethylenically unsaturated bond can be used.

The ethylenically unsaturated polymerizable compound has a chemical formation of monofunctional polymerizable compound, a multifunctional polymerizable compound, or the mixture of these compounds. As the monofunctional polymerizable compound, for example, an unsaturated carboxylic acid (for example, acrylic acid, methacrylic acid, itaconic acid, crotonic acid, isocrotonic acid, maleic acid, etc.) or their esters, amides, etc., can be exemplified. As the multifunctional polymerizable compound, esters of unsaturated carboxylic acid and aliphatic polyhydric alcohol compound, amides of unsaturated carboxylic acid and aliphatic amine compound are used.

Further, unsaturated carboxylic ester having nucleophilic substituent such as hydroxyl group, amino group, mercapto group, etc., an addition reaction product of amides and isocyanates, epoxies, and dehydration condensation reaction product of carboxylic acid, etc. can be used. Further, unsaturated carboxylic ester having electrophilic substituent such as isocyanate group, epoxy group, etc., or an addition reaction product of amides, alcohols, amines, and thiols, and in addition, unsaturated carboxylic ester having leaving substituent such as halogen group, tosyloxy group, etc. or substitution reaction product of amides, alcohols, amines, and thiols can be used.

As a specific example of a radical polymerizable compound, which is esters of unsaturated carboxylic acid and aliphatic polyhydric alcohol compound, for example, although a (meth)acrylic acid ester is typical, either monofunctional or multifunctional radical polymerizable compounds can be used.

As specific examples of a monofunctional (meth)acrylate, for example, tolyloxyethyl (meth)acrylate, phenyloxyethyl (meth)acrylate, cyclohexyl (meth)acrylate, ethyl (meth)acrylate, methyl (meth)acrylate, isobornyl (meth)acrylate, tetrahydrofurfuryl (meth)acrylate, etc., can be exemplified.

As specific examples of a bifunctional (meth)acrylate, for example, ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, dipentaerythritol di(meth)acrylate, etc., can be exemplified.

As specific examples of the trifunctional (meth)acrylate, for example, trimethylolpropane tri(meth)acrylate, trimethylol ethane tri(meth)acrylate, alkylene oxide-modified tri(meth)acrylate of trimethylolpropane, pentaerythritol tri(meth)acrylate, dipentaerythritol tri(meth)acrylate, trimethylol propane tri((meth)acryloyloxypropyl)ether, isocyanuric acid alkylene oxide-modified tri(meth)acrylate, propionic acid dipentaerythritol tri(meth)acrylate, tri((meth)acryloyloxyethyl)isocyanurate, hydroxypivalaldehyde-modified dimethylol propane tri(meth)acrylate, sorbitol tri(meth)acrylate, etc., can be exemplified.

As specific examples of a tetrafunctional (meth)acrylate, for example, pentaerythritol tetra(meth)acrylate, sorbitol tetra(meth)acrylate, ditrimethylolpropane tetra(meth)acrylate, propionic acid dipentaerythritol tetra(meth)acrylate, ethoxylated pentaerythritoltetra(meth)acrylate, etc., can be exemplified.

As specific examples of a pentafunctional (meth)acrylate, for example, sorbitol penta(meth)acrylate, dipentaerythritol penta(meth)acrylate, etc., can be exemplified.

As specific examples of a hexafunctional (meth)acrylate, for example, dipentaerythritol hexa(meth)acrylate, sorbitol hexa(meth)acrylate, alkylene oxide-modified hexa(meth)acrylate of phosphazene, caprolactone-modified dipentaerythritol hexa(meth)acrylate, etc., can be exemplified.

As a polymerizable compound other than (meth)acrylate, for example, itaconic acid ester, crotonic acid ester, isocrotonic acid ester, maleic acid ester, etc., can be exemplified.

As an itaconic acid ester, for example, ethylene glycol diitaconate, propylene glycol diitaconate, 1,3-butane diol diitaconate, 1,4-butane diol diitaconate, tetramethylene glycol diitaconate, pentaerythritol diitaconate, sorbitol tetraitaconate, etc., can be exemplified.

As a crotonic acid ester, for example, ethylene glycol dicrotonate, tetramethylene glycol dicrotonate, pentaerythritol dicrotonate, sorbitol tetra dicrotonate, etc., can be exemplified.

As an isocrotonic acid ester, for example, ethylene glycol diisocrotonate, pentaerythritol diisocrotonate, sorbitol tetraisocrotonate, etc., can be exemplified.

As a maleic acid ester, for example, ethylene glycol dimaleate, triethylene glycol dimaleate, pentaerythritol dimaleate, sorbitol tetra maleate, etc., can be exemplified.

As examples of other esters, for example, fatty alcohol esters as disclosed in Japanese Examined Patent Publication No. 46-27926, Japanese Examined Patent Publication No. 51-47334, and Japanese Laid-open Patent Application Publication No. 57-196231, esters having aromatic skeleton as disclosed in Japanese Laid-open Patent Application Publication No. 59-5240, Japanese Laid-open Patent Application Publication No. 59-5241, and Japanese Laid-open Patent Application Publication No. 2-226149, and esters including amino group as disclosed in Japanese Laid-open Patent Application Publication No. 1-165613, etc., can be used.

Further, as specific examples of amino monomer of unsaturated carboxylic acid and aliphatic polyamine compound, for example, methylenebis-acrylamide, methylenebis-methacrylamide, 1,6-hexamethylenebis-acrylamide, 1,6-hexamethylenebis-methacrylamide, diethylenetriamine tris acrylamide, xylylenebis-acrylamide, xylylenebis-methacrylamide, etc., can be exemplified.

As other preferred amide-based monomers, for example, amid-based monomer having a cyclohexylene structure as described in Japanese Examined Patent Publication No. 54-21726, etc., can be exemplified.

Further, an urethane based addition polymerizable compound produced using addition reaction of isocyanate and hydroxyl groups is also preferable, and as specific examples, for example, a vinyl urethane compound including 2 or more polymerizable vinyl groups in one molecule, in which a vinyl monomer including a hydroxyl group as shown by the following formula (1) is added to a polyisocyanate compound having two or more isocyanate groups in one molecule as described in Japanese Examined Patent Publication No. 48-41708, etc., can be exemplified.

CH₂═C(R¹)COOCH₂CH(R²)OH (1)

(In the formula (1), R¹ and R² individually represent H or CH³, respectively.)

In the present invention, a cationic ring-opening polymerization compound having one or more cyclic ether groups such as epoxy group, oxetane group, etc., in a molecule can be suitably used as an ultraviolet curable resin (polymerizable compound).

As a cationic polymerizable compound, for example, curable compounds including ring-opening polymerization group, etc., can be exemplified, and among them, a heterocyclic group-containing curable compound is especially preferred. As such curable compound, for example, the followings are exemplified: cyclic imino ethers such as epoxy derivative, oxetane derivative, tetrahydrofuran derivative, cyclic lactone derivative, cyclic carbonate derivative, oxazoline derivative, etc., vinyl ethers, etc., and among these compounds, epoxy derivative, oxetane derivative, and vinyl ethers are preferred.

As an example of preferred epoxy derivative, for example, monofunctional glycidyl ethers, multifunctional glycidyl ethers, monofunctional alicyclic epoxies, polyfunctional alicyclic epoxies, etc., can be exemplified.

As an example of specific compounds of glycidyl ethers, for example, the followings are exemplified: diglycidyl ethers (e.g., ethylene glycol diglycidyl ether, bisphenol A diglycidyl ether, etc.), more than trifunctional glycidyl ethers (e.g., trimethylol ethane triglycidyl ether, trimethylol propane triglycidyl ether, glycerol triglycidyl ether, triglycidyl tris-hydroxyethyl isocyanurate, etc.), more than tetrafunctional glycidyl ethers (e.g., sorbitol tetraglycidyl ether, pentaerythritol tetraglycyl ether, poly-glycidyl ether of cresol novolac resin, poly-glycidyl ether of phenol novolac resin, etc.), alicyclic epoxies (e.g., CELLOXIDE 2021P, CELLOXIDE 2081, EPOLEAD GT-301, EPOLEAD GT-401 (the aforementioned compounds made by Daicel Chemical Industries, Ltd.), EHPE (Daicel Chemical Industries, Ltd.), polycyclohexyl epoxy methyl ether of phenol novolac resin, etc.), oxetanes (e.g., QX-SQ, PNOX-1009 (the aforementioned compounds made by Toagosei Co., LTD.), etc.

As the polymerizable compounds, it is preferable to use alicyclic epoxy derivative. The phrase “alicyclic epoxy group” refers to the partial structure where the double bond of cycloalkenes ring such as cyclopentene group, cyclohexene group, etc. is epoxidized by an appropriate oxidant such as hydrogen peroxide, peracide, etc.

As the alicyclic epoxy compounds, polyfunctional alicyclic epoxy having two or more cyclohexene oxide groups or cyclopentene oxide groups in a molecule is preferred. As a specific example of the alicyclic epoxy compounds, for example, the followings are exemplified: 4-vinyl cyclohexene dioxide, (3,4-epoxy cyclohexyl)methyl-3,4-epoxycyclohexylcarboxylate, di(3,4-epoxycyclohexyl) adipate, di(3,4-epoxycyclohexylmethyl) adipate, bis(2,3-epoxy cyclopentyl) ether, di(2,3-epoxy-6-methylcyclohexylmethyl) adipate, dicyclopentadiene dioxide, etc.

A glycidyl compound having normal epoxy group, which does not have alicyclic structure in a molecule can be individually used or can be used with the aforementioned alicyclic epoxy compounds.

As such normal glycidyl compound, for example, although glycidyl ether compound, glycidyl ester compound, etc., can be exemplified, the glycidyl ether compound is preferably used.

As a specific example of the glycidyl ether compounds, for example, the followings are exemplified: aromatic glycidyl ether compounds such as 1,3-bis(2,3-epoxypropyloxy)benzene, bisphenol A type epoxy resin, bisphenol F type epoxy resin, phenol-novolac type epoxy resin, cresol-novolac type epoxy resin, trisphenolmethane type epoxy resin, etc., aliphatic glycidyl ether compounds such as 1,4-butanediol glycidyl ether, glycerol triglycidyl ether, propylene glycol diglycidyl ether, trimethylolpropane tritriacontanoic glycidyl ether, etc. As the glycidyl esters, for example, the followings are exemplified: glycidyl esters of linolenic acid dimer, etc.

As the polymerizable compounds, the compound having oxetanyl group which is four-membered cyclic ether (hereinafter referred to as “oxetane compound”) can be used. The compound including oxetanyl group is the compound having one or more oxetanyl group in a molecule.

The content rate of the bonding agent in the bonding liquid 12 is preferably 80 mass % or more and more preferably 85 mass % or more. With this, the mechanical strength of the three-dimensional shaped object 10 to be finally obtained can be made particularly excellent.

### Other Components

Further, the bonding liquid 12 may include components other than the aforementioned components. As such components, for example, the followings are exemplified: various coloring agents such as pigment, dye, etc.; dispersant; surfactant; sensitizer; polymerization accelerator; solvent; penetration enhancer; wetting agent (humectant); fixing agent; antifungal agent; preservative; antioxidant; ultraviolet absorber; chelating agent; pH adjuster; thickener; filler; aggregation inhibitor; defoamer, etc.

Particularly, since the bonding liquid 12 includes a coloring agent, the three-dimensional shaped object 10 colored as the corresponding color of the coloring agent can be obtained.

Particularly, the light resistance of the three-dimensional shaped object 10 can be made excellent by including the pigment as the coloring agent. As the pigments, inorganic pigments and organic pigments can be used.

As the inorganic pigments, for example, the followings are exemplified: carbon blacks (C.I. pigment black 7) such as furnace black, lampblack, acetylene black, channel black, etc., iron oxide, titanium oxide, etc., and it can be used by combining one or more selected from these inorganic pigments.

Among these inorganic pigments, titanium oxide is preferred to present desirable white.

As the organic pigments, for example, the followings are exemplified: an azo pigment such as an insoluble azo pigment, a condensed azo pigment, azolake, a chelate azo pigment, etc., a polycyclic pigment such as a phthalocyanine pigment, a perylene and perynone pigment, an anthraquinone pigment, a quinacridone pigment, a dioxane pigment, a thioindigo pigment, an isoindolinone pigment, a quinophthalone pigment, etc., dye chelate (e.g., basic dye type chelate, acidic dye type chelate, etc.), dye type lake (e.g., basic dye type lake, acidic dye type lake, etc.), nitro pigment, nitroso pigment, aniline black, daylight fluorescent pigment, etc., and it can be used by combining one or more selected from these organic pigments.

In further detail, as the carbon black used as a black pigment (black), for example, the followings are exemplified: No. 2300, No. 900, MCF88, No. 33, No. 40, No. 45, No. 52, MA7, MA8, MA100, No. 2200B, etc. (the aforementioned pigments made by Mitsubishi Chemical Corporation), Raven 5750, Raven 5250, Raven 5000, Raven 3500, Raven 1255, Raven 700, etc. (the aforementioned pigments made by Carbon Columbia Corporation), Regal 400R, Regal 330R, Regal 660R, Mogul L, Monarch 700, Monarch 800, Monarch 880, Monarch 900, Monarch 1000, Monarch 1100, Monarch 1300, Monarch 1400, etc. (the aforementioned pigments made by CABOT JAPAN K.K.), Color Black FW1, Color Black FW2, Color Black FW2V, Color Black FW18, Color Black FW200, Color Black S150, Color Black 5160, Color Black 5170, Printex 35, Printex U, Printex V, Printex 140U, Special Black 6, Special Black 5, Special Black 4A, Special Black 4, etc. (the aforementioned pigments made by Degussa Corporation).

As a white pigment (white), for example, the followings are exemplified: C.I. Pigment White 6, 18, 21, etc.

As a yellow pigment (yellow), for example, for example, the followings are exemplified: C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, etc.

As a magenta pigment (magenta), for example, the followings are exemplified: C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, 50, etc.

As a cyan pigment (cyan), for example, the followings are exemplified: for example, C.I. Pigment Blue 1, 2, 3, 15, 15:1, 15:2, 15:3, 15:34, 15:4, 16, 18, 22, 25, 60, 65, 66, C.I. Bat Blue 4, 60, etc.

Further, as pigments other than the aforementioned pigments, for example, the followings are exemplified: C.I. Pigment Green 7, 10, C.I. Pigment Brown 3, 5, 25, 26, C.I. Pigment Orange 1, 2, 5, 7, 13, 14, 15, 16, 24, 34, 36, 38, 40, 43, 63, etc.

When the bonding liquid 12 includes pigments, the average particle diameter of the pigments is preferably equal to or less than 300 nm, and it is more preferably equal to or more than 50 nm and equal to or less than 250 nm. With this, the ejection stability of the bonding liquid 12 and the dispersion stability of the pigments in the bonding liquid 12 can be made particularly excellent, and an image forming further excellent image quality can be provided.

Further, as a dye, for example, the followings are exemplified: an acidic dye, a direct dye, a reactive dye, a basic dye, etc. It can be used by combining one or more selected from these dyes.

As a specific example of dyes, for example, the followings are exemplified: C.I. Acid Yellow 17, 23, 42, 44, 79, 142, C.I. Acid Red 52, 80, 82, 249, 254, 289, C.I. Acid Blue 9, 45, 249, C.I. Acid Black 1, 2, 24, 94, C.I. Food Black 1, 2, C.I. Direct Yellow 1, 12, 24, 33, 50, 55, 58, 86, 132, 142, 144, 173, C.I. Direct Red 1, 4, 9, 80, 81, 225, 227, C.I. Direct Blue 1, 2, 15, 71, 86, 87, 98, 165, 199, 202, C.I. Direct Black 19, 38, 51, 71, 154, 168, 171, 195, C.I. Reactive Red 14, 32, 55, 79, 249, C.I. Reactive Black 3, 4, 35, etc.

When the bonding liquid 12 includes the coloring agent, the content ratio of the coloring agent in the bonding liquid 12 is preferably equal to or more than 1 mass % and equal to or less than 20 mass %. With this, particularly excellent concealability and color reproducibility can be obtained.

Particularly, when the bonding liquid 12 includes titanium oxide as the coloring agent, the content ratio of the titanium oxide in the bonding liquid 12 is preferably equal to or more than 12 mass % to equal to or less than 18 mass %, and more preferably, equal to or more than 14 mass % and equal to or less than 16 mass %. With this, particularly excellent concealability can be obtained.

When the bonding liquid 12 includes the pigment, and when it further includes the dispersant, the dispersibility of the pigment can be made excellent. As the dispersant, it is not particularly limited, but for example, the following is exemplified: a dispersant commonly used for adjusting pigment dispersion such as a polymer dispersant, etc. As a specific example of the polymer dispersant, for example, the followings are exemplified: a polymer dispersant mainly composed of one or more of polyoxyalkylene polyalkylene polyamine, vinyl polymer and copolymer, acrylic polymer and copolymer, polyester, polyamide, polyimide, polyurethane, amino-based polymer, silicon-containing polymer, sulfur-containing polymer, fluorine-containing polymer, and epoxy resin, etc. As the polymer dispersant available on market, for example, the followings are exemplified: AJISPER SERIES made by Ajinomoto Fine-Techno Co., Inc., SOLSPERSE 36000 available from Noveon Inc., DISPERBYK SERIES made by BYK Co., DISPARLON SERIES made by Kusumoto Chemical Ltd., etc.

When the bonding liquid 12 includes a surfactant, the wear resistance of the three-dimensional shaped object 10 can be made further excellent. As the surfactant, it is not particularly limited, but for example, polyester-modified silicone, polyether-modified silicone, etc. as the silicone-based surfactant can be used, and it is preferable that polyether-modified polydimethylsiloxane or polyester-modified polydimethyl siloxane is used. As a specific example of the surfactant, for example, the followings are exemplified: BYK-347, BYK-348, BYK-UV3500, 3510, 3530, 3570 (the aforementioned products are the trade name of BYK Co.), etc.

Further, the bonding liquid 12 may include a solvent. Therefore, viscosity adjustment of the bonding liquid 12 can be appropriately performed, and even if the bonding liquid 12 includes high viscosity components, the ejection stability of the bonding liquid 12 by the ink-jet method can be made particularly excellent.

As a solvent, for example, the followings are exemplified: (poly)alkylene glycol monoalkyl ethers such as ethylene glycol monomethyl ether, ethylene glycol monoethyl ether, propylene glycol monomethyl ether, propylene glycol monoethyl ether, etc.; acetic acid esters such as ethyl acetate, n-propyl acetate, iso-propyl acetate, n-butyl acetate, iso-butyl acetate, etc.; aromatic hydrocarbons such as benzene, toluene, xylene, etc.; ketones such as methylethyl ketone, acetone, methyl isobutyl ketone, ethyl-n-butyl ketone, diisopropyl ketone, acetylacetone, etc.; alcohols such as ethanol, propanol, butanol, etc., and it can be used by combining one or more selected from these solvents.

Further, the viscosity of the bonding liquid 12 is preferably equal to or more than 10 mPa·s and equal to or less than 30 mPa·s, and more preferably, equal to or more than 15 mPa·s and equal to or less than 25 mPa·s. With this, the ejection stability of the bonding liquid 12 by the ink-jet method can be particularly excellent. In this specification, the viscosity is the value measured in 25° C. by using E-type viscometer (Tokyo Keiki Co., Ltd. VISCONIC ELD).

Further, plural types of the bonding liquid 12 may be used in the manufacturing of the three-dimensional shaped object 10.

For example, the bonding liquid 12 that includes the coloring agent (color ink) and the bonding liquid 12 that does not include the coloring agent (clear ink) may be used. With this, for example, in an appearance of the three-dimensional shaped object 10, the bonding liquid 12 that includes the coloring agent is used as the bonding liquid 12 that is applied to the region influencing the color tone, and in an appearance of the three-dimensional shaped object 10, the bonding liquid 12 that does not include the coloring agent can be used as the bonding liquid 12 that is applied to the region not influencing the color tone so that it has an advantage in the viewpoint from the reduction of the production cost of the three-dimensional shaped object 10. Further, in the three-dimensional shaped object 10 to be finally obtained, plural types of the bonding liquid 12 may be commonly used to provide the region (coating layer) formed by using the bonding liquid 12 that does not include the coloring agent on the outer surface of the region formed by using the bonding liquid 12 that includes the coloring agent.

Further, for example, the plural types of the bonding liquid 12 that includes coloring agent having different components may be used. With this, the reproducible range which can reproduce colors can be widened by combining these bonding liquid 12.

When plural types of the bonding liquid 12 are used, at least the bonding liquid 12 of cyan, the bonding liquid 12 of magenta, and the bonding liquid 12 of yellow are preferably used. With this, the reproducible range which can represent colors can be further widened by combining these object bonding liquid 12.

Further, by using a white colored (white) bonding liquid 12 and another colored bonding liquid 12 together, for example, the following effects can be obtained. That is, the three-dimensional shaped object 10 to be finally obtained can be provided with the first region where the white bonding liquid 12 is applied and the region (the second region) provided in the outer surface side than the first region where the bonding liquid 12 of a color other than white is applied. With this, the first region where the bonding liquid 12 of white is applied can demonstrate concealability, and colorfulness of the three-dimensional shaped object 10 can be enhanced.

### Three-Dimensional Shaped Object

The three-dimensional shaped object of the present invention can be manufactured by using the aforementioned manufacturing method and three-dimensional shaped object manufacturing device. With this, the three-dimensional shaped object having excellent dimensional accuracy and in which occurrences of defects are effectively prevented can be provided.

The use of the three-dimensional shaped object of the present invention is not limited, but the followings are exemplified: ornament exhibition such as dolls, figures, etc., medical equipment, etc.

Further, the three-dimensional shaped object of the present invention may be used for any of a prototype, a mass-produced product, and a made-to-order product.

Although preferred embodiments of the present invention have been described above, the present invention is not limited to these embodiments.

For example, in the embodiments shown in FIGS. 1A-1D, 2A-2D and 3A-3C, a configuration in which the stage is lowered was representatively explained, but in the manufacturing device of the present invention, in the moving process, the stage and the side surface supporting section can move relatively, and for example, the side surface supporting section can be configured to move upward.

Further, in the aforementioned embodiment, although a case in which the adhesion preventing part is a liquid repellent film, etc., was representatively explained, in the present invention, the adhesion preventing part can be any unit having the function of preventing the adhesion of the composition (layer) to the surface of the side surface supporting section. For example, the adhesion preventing part can be a unit in which the surface of the side surface supporting section is mirror finished. Further, the surface of the side surface supporting section can be constituted by POM (polyacetal).

Further, in the aforementioned embodiment, although a configuration in which a liquid repellent film is provided on the surface of the side surface supporting section is explained, for example, the whole side surface supporting section can be constituted by similar materials as the aforementioned liquid repellent film. That is, the side surface supporting section itself may function as an adhesion preventing part. In such a case, effects similar to the aforementioned effects can be obtained.

Further, as a flattening unit, a roller, etc., can be used in place of the aforementioned squeegee.

Further, the three-dimensional shaped object manufacturing device of the present invention can be provided with a collection mechanism that is not illustrated for collecting compositions among the compositions supplied from the composition supply section that is not used for forming the layers. With this, since excessive composition can be prevented from accumulating in the layer formation section and a sufficient amount of composition can be supplied, occurrences of defects in the layer can be effectively prevented and the three-dimensional shaped object can be manufactured more stably. Further, the collected composition can be used again for manufacturing the three-dimensional shaped object, which contributes to the reduction in the manufacturing cost of the three-dimensional shaped object and is also preferable in view of saving energy.

Further, the three-dimensional shaped object manufacturing device of the present invention can be provided with a collection mechanism for collecting compositions removed by the un-bonded particle removal process.

Further, in the aforementioned embodiments, although it is explained that bonded portions are formed with respect to all layers, the layers in which bonded portions are not formed can be provided. For example, the layer formed above the stage can be formed without a bonded portion and allowed to function as a sacrificial layer.

Further, in the aforementioned embodiment, although a case in which the bonding liquid application process is performed by the ink-jet method was explained primarily, the bonding liquid application process can be performed by other methods (e.g., another printing method).

Further, in the aforementioned embodiment, although it is explained that, in addition to the layer forming process and the bonding liquid application process, the curing process is also repeatedly performed along with the layer forming process and the bonding liquid application process, the curing process is not required to be repeatedly performed. For example, the processes can be performed all together after forming the laminated body having a plurality of uncured layers.

Further, in the aforementioned embodiments, although it was explained that the moving process is performed after performing the bonding liquid application process and the bonding process, the moving process can be performed at any time after the layer forming process for forming the first layer and before the layer forming process for forming the second layer.

Further, in the manufacturing method according to the present invention, a pretreatment process, an intermediate process, and a post-treatment process can be performed as necessary.

As a pretreatment process, for example, a cleaning step of the shaping stage, etc., is exemplified.

As an intermediate process, for example, in a case in which the three-dimensional shaping composition is formed in a pellet form, a process to stop heating, etc., (water-soluble resin solidifying process) can be provided between the layer forming process and the bonding liquid application process. With this, the water-soluble resin becomes a solid state, and the layers can be obtained, so that the bonding forces of the granular substances are stronger. Further, for example, when the three-dimensional shaping composition includes a solvent component such as water (dispersant), a solvent component removing process for removing the solvent component can be provided between the layer forming process and the bonding liquid application process. With this, the layer forming process can be performed more smoothly, and the unintentional unevenness of the thickness of the layer to be formed can be effectively prevented. As a result, three-dimensional shaped object having higher dimensional accuracy can be formed with higher productivity.

As a post-treatment process, for example, a shape adjustment process for performing a cleaning process, deburring, etc., a coloring process, a coating layer forming process, a light irradiation treatment for assuredly curing an uncured bonding agent, a bonding agent curing completion process for performing a heat treatment, etc., are exemplified.

In the aforementioned embodiments, although a method including the bonding liquid application process and the curing process (bonding process) is primarily explained, for example, when the bonding liquid including a thermoplastic resin as the bonding agent is used, it is not required to provide a curing process (bonding process) after the bonding liquid application process (the bonding process can be combined with the bonding liquid application process). Further, in such a case, the three-dimensional shaped object manufacturing device is not required to be provided with an energy line irradiation unit (curing unit).

Further, in the aforementioned embodiments, although the flattening unit is explained to move above the stage, the stage may move, which changes the positional relationship between the stage and the squeegee, and as a result flattening is carried out.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A three-dimensional shaped object manufacturing device adapted to produce a three-dimensional shaped object by laminating layers using a pasty composition containing granular substances, the three-dimensional shaped object manufacturing device comprising:
a stage in which the composition is supplied and the layers are formed;
a side surface supporting section arranged on a side surface of the stage; and
an adhesion preventing part configured and arranged to prevent adhesion of the composition on a surface of the side surface supporting section,
wherein the stage is movable relative to the side surface supporting section in a lamination direction of the layers.

2. The three-dimensional shaped object manufacturing device according to claim 1, wherein
the adhesion preventing part is a liquid repellent film provided on the surface of the side surface supporting section.

3. The three-dimensional shaped object manufacturing device according to claim 1, wherein
the adhesion preventing part is a heating unit configured and arranged to heat the side surface supporting section.

4. The three-dimensional shaped object manufacturing device according to claim 1, wherein
the stage is configured to be movable in the lamination direction of the layers.

5. The three-dimensional shaped object manufacturing device according to claim 1, wherein
the side surface supporting section is configured to be movable in the lamination direction of the layers.

6. The three-dimensional shaped object manufacturing device according to claim 1, further comprising
a bonding liquid application unit configured and arranged to apply a bonding liquid for biding the granular substances.

7. The three-dimensional shaped object manufacturing device according to claim 6, further comprising
an ultraviolet irradiation unit,
wherein the bonding liquid contains an ultraviolet curable resin.

8. A manufacturing method of a three-dimensional shaped object, comprising:
manufacturing the three-dimensional shaped object using the three-dimensional shaped object manufacturing device according to claim 1.

9. A manufacturing method of a three-dimensional shaped object comprising:
performing a series of processes plural times, the series of processes including
a layer forming process which forms a layer using a pasty composition containing granular substances, and
a moving process which moves the layer downward relative to a side surface supporting section configured and arranged to support a side surface of the layer,
wherein the performing the series of processes being performed using a device including an adhesion preventing part configured and arranged to prevent adhesion of the composition to a surface of the side surface supporting section.

10. The manufacturing method according to claim 9, further comprising
a bonding liquid application process which applies a bonding liquid for bonding the granular substances to the layer.

11. A three-dimensional shaped object manufactured using the three-dimensional shaped object manufacturing device according to claim 1.

12. A three-dimensional shaped object manufactured using the method according to claim 8.
